(19) United States
(12) Patent Application Publication
(10) Pub. No.: US 2025/0133423 A1
(43) Pub. Date: Apr. 24, 2025

(54) Methods and Apparatus for Implementing a Mesh Network of Access Points Capable of Providing Multiple Levels of Service

(71) Applicant: Charter Communications Operating, LLC, St. Louis, MO (US)

(72) Inventors: Diwelawatte P. Jayawardene, Centennial, CO (US); Matthew G. Hubbard, Centennial, CO (US)

(21) Appl. No.: 18/383,414

(22) Filed: Oct. 24, 2023

(51) Int. Cl. H04W 24/04; H04W 28/02

(52) U.S. Cl. CPC H04W 24/04; H04W 28/0278

(57) ABSTRACT

Access points (APs) are coupled together to support communications services provided by the APs to User Equipment devices (UEs). APs which do not have direct access to the Internet support communications with devices coupled to the Internet via interconnectivity links, e.g., Point to Point (PtP) links or other links between APs. Interconnectivity links corresponding to multiple different frequency bands and/or communications standards are supported. In addition, multiple service networks are supported at each AP for providing service to UEs. An access point receives packets directed to a common IP address of the access point and a higher order MAC scheduler determines which of the available communications service networks at an AP to use for packet delivery. A MANC monitors interconnectivity link status and service network status and controls an AP to switch between a normal mode of operation to a failure mode of operation when a failure condition is detected.

### FIELD

The present application relates to wireless communications systems and more particularly to methods and apparatus for connecting access points (APs) and providing wireless communications services to User Equipment (UE) such as cell phones and other types of mobile and/or stationary communications devices.

### BACKGROUND

In today's implementation of meshed networks that use 802.11ay solutions (e.g., 60 GHz), there is no guarantee of service when the line of sight between access points is physically blocked or when the access mechanism completely fails. A resulting obstruction(s) has to potential to completely disrupt service of the network.

FIG. 1 is a drawing of a communications system 100 and a corresponding legend 150. Communications system 100 includes a plurality of access points (APs) (AP1 102, AP2 104, AP3 106, AP4 108, AP5 110) and Internet 112 coupled together. Legend 150 indicates: i) that solid line circles such as circle 152 represent operational outdoor WiFi coverage areas, ii) dashed line circles such as circle 154 represents inoperable outdoor WiFi coverage areas, and iii) solid line ovals such as oval 156 represent 60 GHz Point to Point/Point to Multi-Point (PtP/PtMP) links, in system 100.

AP1 102, which is a network anchor, is coupled to the Internet 112 via communication link 113, e.g., a wireline or fiber optic communications link. AP1 102 is coupled to AP2 104 via 60 GHz PtP/PtMP link 114. AP1 102 is coupled to AP3 106 via 60 GHz PtP/PtMP link 116. AP1 102 is coupled to AP4 108 via 60 GHz PtP/PtMP link 118. AP1 102 is coupled to AP5 110 via 60 GHz PtP/PtMP link 120. AP2 104 is coupled to AP3 106 via 60 GHz PtP/PtMP link 122. AP3 106 is coupled to AP4 108 via 60 GHz PtP/PtMP link 124. AP4 108 is coupled to AP5 110 via 60 GHz PtP/PtMP link 126.

In the example, of FIG. 1, obstruction 128 disrupts, e.g., blocks, communications along links 122, 116, e.g., rendering those links inoperative are indicated by X's 132, 134; and obstruction 130 disrupts, e.g., blocks, communications along links 118, 126, e.g., rendering those links inoperative are indicated by X's 136, 138. Link 124 is considered a link failure as indicated by X 140 due to incomplete network connectivity. In this example, the outdoor WiFi coverage is inoperable for AP3 106 and AP4 108.

Based on the above discussion there is a need for new methods and apparatus to enhance service in meshed networks. It would be advantages is at least some of these new methods and apparatus provided increased connectivity options between access points in the mesh network and/or increase the number of different access networks available to provide service to end user devices. It would be beneficial if at least some of these new methods and apparatus provide for fast and efficient switching thus minimizing disruptions to service during a switchover between alternative available network interconnections and/or alternative available access networks.

### SUMMARY

In various embodiments access points (APs) are coupled together to support communications services provided by the APs to User Equipments (UEs), also sometimes referred to as user equipment devices, e.g., cell phones, mobile devices, fixed home devices, etc., which are within the range of one or more of the APs. One or more of the APs may act as network anchors that provide connectivity to the Internet and/or other remote networks. In many cases APs which do not have direct access to the Internet support communications with devices coupled to the Internet via interconnectivity links, e.g., Point to Point (PtP) links or other links, which allow data and/or other traffic from a UE to be communicated through various access points to and/or from the Internet.

In various embodiments an access point receives packets directed to a common Internet Protocol (IP) address of the access point. The common IP address is used to route packets to the access point to which the IP address corresponds for transmission to UEs by any of various radios included in the access point. In the present application the term radio is generally used to refer to a radio transceiver capable of transmitting and/or receiving wireless signals. In some embodiments, an access point includes multiple radios, e.g., 3 different radios each of which corresponds to a different frequency band or communications network. Access points in some embodiments include a higher order common medium access control (MAC) scheduler that assigns received packets stored in a common IP buffer at the AP to the one of a plurality of MAC schedulers with each MAC scheduler corresponding to a different one of the AP radios and thus different wireless networks supported by the AP. The higher order common MAC scheduler determines which radio should transmit the particular received packets being assigned for transmission scheduling and assigns the packet to be transmitted to the MAC scheduler corresponding to the radio to be used, e.g., the higher order common MAC scheduler assigns the packet to be transmitted to a first MAC scheduler corresponding to a first radio. A transmitted packet is deleted from the common IP buffer in response to an ACK being received at the AP indicating that it was successfully received by the UE to which the packet was to be communicated. In response to an AP determining that a transmitted packet was not successfully received, e.g., as indicated by no ACK being received within a predetermined amount of time from the time the packet was transmitted or based on a NAK being received with respect to the transmitted packet, the packet which was not successful communicated is reassigned by the higher order common MAC scheduler to a different MAC scheduler at the AP, e.g., the second MAC scheduler corresponding to a second radio or a third MAC scheduler corresponding to a third radio so that the packet is transmitted by another one of the radios at the AP. The radio used for retransmission will be different from the radio used to initially transmit the packet since the retransmission is assigned to a different MAC scheduler than the one originally used. The MAC scheduler to which a packet is assigned for retransmission will control the corresponding radio to retransmit the packet over a wireless link corresponding to the network to which the radio corresponds. If the retransmitted packet is successfully received as indicated by an acknowledgement being received at the AP, it will be deleted from the common IP packet buffer. Failure to receive an acknowledgement will result in retransmission by yet another radio if the UE to which the packet is directed is entitled to receive packets from the other radio in the access point, e.g., a Citizens Broadband Radio Service (CBRS) radio.

Multiple packet transmission failures by a radio at the AP may, and sometimes does, result in the AP determining that the radio encountering the repeated failures is in a failure state. The failure state may be, and sometimes is, reported to a network control device, e.g., a Multi-Access Network Controller (MANC) in response to the MANC requesting network and/or radio status information from the first AP and/or as part of automatic reporting to the MANC by the AP.

An access point, which receives packets at the interface, corresponding to the IP address of the AP, which are directed to a UE, which is receiving service from the AP but which is out of range of the first and second radios of the AP, will have the received packets transmitted to the UE from a third radio, e.g., the CBRS radio of the AP. The third radio has a longer range than the first and second radios and will be used when the UE has a service priority level entitling it to CBRS service and the UE can not be reached by using the first and second, e.g., WiFi radios, at the AP. To ensure delivery of the packets to the UE, entitled to the CBRS service when it is out of range of the first and second radios, the higher order common MAC scheduler assigns packets corresponding to the UE, which is out of range of the first and second radios, to the third MAC scheduler corresponding to the CBRS network. Given the AP first checks to make sure that the UE, entitled to receive CBRS service, is not within range of the first and second radios before using the third radio to transmit to the UE, service is provided to the UE entitled to the CBRS service (sometimes referred to as extended range service) via the CBRS radio and CBRS network when WiFi service is not available due to range or other limitations but not at other times.

Interconnectivity links between APs allow the APs to be configured into one or more networks, e.g., mesh networks or networks having another configuration. For purposes of network resiliency in one exemplary embodiment, access points include multiple radios, e.g., multiple radio transceivers. In various embodiments these radios support not only communication and services provided to UEs but also inter-AP communication. The different transceivers in an AP may, and often do, support communications in different frequency bands and/or operate according to different communications standards. For example, in one exemplary embodiment APs are provided with first, second and third radios where the first radio is a 60 GHz radio transceiver that supports WiFi communications, the second radio is a 5 GHz radio transceiver that supports WiFi communications, and the third radio is a CBRS transceiver that supports CBRS communications.

In some embodiments communications between access points is supported by each of the radios with first type interconnectivity links (e.g., PtP 60 GHz links) being supported by the first radios in the APs, a second type interconnectivity link (5 GHz PtP links) being supported by the second radios in the APs and a third type interconnectivity link (e.g., CBRS links) being supported by the third radios in the APs.

In addition to supporting inter-AP communications, the first, second and third radios are used, depending on the AP mode of operation, to provide services to UEs. The first radio corresponding to a first frequency band, e.g., 60 GHz frequency band, supports the highest data rates and thus highest throughput of the three radios. Given the higher data rate that is supported by the first radio, the first radio is preferred in many cases and used for both PtP and providing services to UEs during a normal mode of operation, e.g., when the first radio is operating and can successfully communicate with other device under the local operating conditions. The second radio, e.g., the 5 GHz radio, supports a lower data rate than the 60 GHz radio, while the CBRS radio supports a still lower data rate. The CBRS radio may also require the use of licensed spectrum and thus, while supporting a longer range than the other radios, may be more costly to operate than the WiFi radios. Thus, for various reasons it can be desirable to limit or avoid the use of the CBRS radio when possible.

In at least some embodiments the radios of an AP share a common IP address, common IP packet buffer and higher order common MAC scheduler. In this way packets directed to an AP for delivery to a UE, can be delivered to the AP via any of the interconnectivity links to the AP, stored in the common IP packet buffer and then scheduled for delivery to a UE via anyone of the three radios with the higher order common MAC scheduler controlling which radio will be used to deliver a packet to a UE at any given time. The AP can also receive packets from a UE to which it provides service via any one of the radios which are in use at a given time and send it out to the Internet or another AP via the interconnectivity links to the AP receiving the packets from the UE.

In various embodiments during normal mode operation the first radio in an AP is active and operated to support a first service network, e.g., a first WiFi network. While active, the first service network is used to provide service to UEs within coverage range of the first radio of the AP. In at least some embodiments, during normal mode of operation the second and third radios are operated to provide second and third service networks. However, in at least some embodiments while the first service network is operating and providing service to UEs the second service network is operated in an inactive or standby state. In the inactive or standby state the second radio is powered on and, in some cases, transmits a SSID or other network identifier but does not provide data services to UEs. In some embodiments while the first service network at the AP is operating, the third service network, e.g., a CBRS network, is operated in an inactive or standby state with the CBRS radio being powered on but not providing data services to UEs. While in the inactive/standby state the CBRS radio may, and sometimes does, transmit various reference signals and/or identification signals so that UEs are aware of its presence but does not provide data service to UEs.

In other embodiments the second and third radios are not operated during a normal mode of operation in a standby state but are used for transmission or retransmission of packets which can not be delivered by the first radio due to range or other issues. In one such embodiment the second radio has a longer range than the first radio, and the third radio has a longer range than the first and second radios.

The third radio in some cases is a CBRS radio. To receive service from the CBRS radio in some cases the UE must subscribe to a service agreement which provides the UE with a priority level entitling it to receive CBRS service. A UE entitled to receive CBRS service can receive service from an AP when it is outside the range of the first and second radios, e.g., WiFi radios, of the AP but still within CBRS range of the AP from which it is receiving service. The AP is aware of the UEs to which it is providing CBRS service but which are outside the range of the first and second radios and can transmit packets to such UEs over the CBRS radio without first trying to transmit the packets over the first and second radios.

Thus, in some embodiments the third radio, which has a longer range than the first and second radios, is used to provide UEs, within the coverage area of the APs third radio but outside the coverage ranges of the APs first and second radios, service, while UEs within the range of the first radio receive service during normal operation from the first radio.

Thus, as described above while not used in all embodiments, in some embodiments during normal mode operation rather than being placed in standby mode the APs second radio is used to provide service to UEs outside the coverage range of the first radio but within the coverage area of the second radio. In addition, the third radio is not placed in standby mode but is used to provide service to UEs entitled to receive CBRS service based on a service plan, which are outside the range of the first and second radios. Because packets are delivered to an AP via a common IP address and are stored in a common IP packet buffer at an AP, the device sending the packets for delivery to a UE need not know which radio at an AP will be used to deliver the packets. The AP can, and in some embodiments does, try to transmit the packets to a UE first via the first radio and when unsuccessful then transmits them via the second radio and then, assuming the UE is entitled to CBRS service via the third radio if the first and second radios were not successful in reaching the UE. The radio transmitting a packet or portion of packet will receive an acknowledgement from the UE upon successful communication. Failure to receive such an acknowledgement (ack) from a UE in response to a transmission within a predetermined amount of time indicates to the AP that the transmission was successful which result in some embodiments in retransmission via the second and/or third radio at the AP.

While the second and third radios may be maintained in standby state or used on an as needed basis to reach particular UEs, during conditions where the first radio at the AP becomes unusable due to a radio failure, hardware fault, obstruction, or interference in the frequency band being used by the first radio, a failure condition with regard to the first radio is determined with respect to the AP encountering the failure. In such a case the AP suffering the failure can be, and sometimes is, switched into a failure mode of operation. In the case of a failure mode of operation, the AP suffering the failure, with regard to the first radio, uses the remaining functional radios in an efficient manner to provide service to the UEs in the coverage area of the AP suffering the fault and to also provide interconnectivity to other APs.

In the case of a fault the total throughput through the AP may be less than in the case where the AP is not operating in a failure condition. While operating in a failure mode of operation the AP priorities packets based on the UE to which they are directed. This prioritization may be, and sometimes is, implemented by the higher order common MAC scheduler. UEs having a highest priority, due to a service agreement, and which are entitled to CBRS delivery, will have packets transmitted to the UEs over the second radio and/or third (CBRS) radio. UEs, which are not entitled to CBRS service, will be limited to service via the second radio with the priority level of the UE being taken into consideration by the higher order common MAC scheduler which is common to the first, second and third radios at the AP subject to the failure condition. Accordingly, while operating in a failure mode the higher order common MAC scheduler will take into consideration the UE service agreement and relative priority with high priority UEs receiving CBRS service and lower priority UEs receiving service via the second (WiFi) radio or if there is insufficient capacity with the lower priority UE packets being dropped by the higher order common MAC scheduler.

In some embodiments the MANC monitors AP operation and control when an AP is switched between a normal mode of operation and a failure mode of operation. The MANC monitors AP interconnectivity links between the APs. In some embodiments this is done by sending messages over the AP interconnectivity links and waiting for a PING response indicating successful communication. Failure to receive one or more expected PING responses results in the MANC determining that the interconnectivity link which failed to provide the expected PING response is non-operational. When the MANC determines that the set of links to an AP corresponding to a particular frequency band have all failed, it determines that the radio corresponding to the frequency band is in a failure condition. For example, when the interconnectivity links at an AP supported by the first radio are determined to have failed, the MANC determines that the first radio is in a failure condition and switches the AP corresponding to the failure from a normal mode of operation to the failure mode of operation. In some embodiments in addition to monitoring interconnectivity links, the MANC monitors or receives information from the APs regarding service network failures. This may be due to interference or other conditions which prevent successful communications to UEs. In the event an AP is unable to successfully communicate with UEs via the first radio at the network, the MANC will consider this a failure of the first radio at the AP and switch the AP subject to the failure condition into a failure mode of operation, assuming it was in a normal mode of operation at the time of the detected failure. Thus failure of interconnectivity links corresponding to the first radio of an AP or failure of the first service network at an AP can and will trigger the MANC to control the AP to switch to the failure mode of operation and to operate in the failure mode until the failure condition is over, e.g., the PtP links are restored or tests show that the first service network has been restored to normal operation and is usable to communicate packets to and/or from UEs.

The MANC provides a centralized network device which stores connectivity information which can be used to control routing in the multi-AP communications system. The MANC can, and in some embodiments does, detect radio failures at APs and controls the switching of APs into and out of failure modes of operation. The MANC also stores network connectivity information which can be used for determining if alternative links are available to reach an AP when one or more of the interconnectivity links fails.

By supporting multiple networks at an AP with a common IP address and common MAC scheduler at individual APs, redundancy, with regard to inter-AP communications and UE service networks, is achieved through a simple to implement failover process that can be triggered by a network device, e.g., MANC or by an AP. By supporting different frequency bands and communications standards redundancy and support for multiple levels of service can be and are provided.

Some embodiments offer a solution to the problem of disruption of service, e.g., due to obstructions between access points and/or due an access mechanism failure, by using a meshed network and various IEEE based (e.g.,802.11ay) and 3GPP (4G/5G CBRS) access mechanisms the risk of service disruption is reduced. In some but not necessarily all embodiments a converged gateway and self-aware intelligence is incorporated into to the network to switch AP modes of operation based on radio conditions, e.g., failures, interference or obstructions which can result in communications failures. Various embodiments support a multi-access service approach using the mesh infrastructure to offer tiered grades of service to UEs based on their needs and/or service agreements.

While various features are discussed in the above summary, all features discussed above need not be supported in all embodiments and numerous variations are possible. Numerous additional features, details and embodiments are described in the detailed description below.

### BRIEF DESCRIPTION OF THE FIGURES

FIG. 1 is a drawing of a mesh network in which obstructions result in disruption of service to portions of the mesh network.

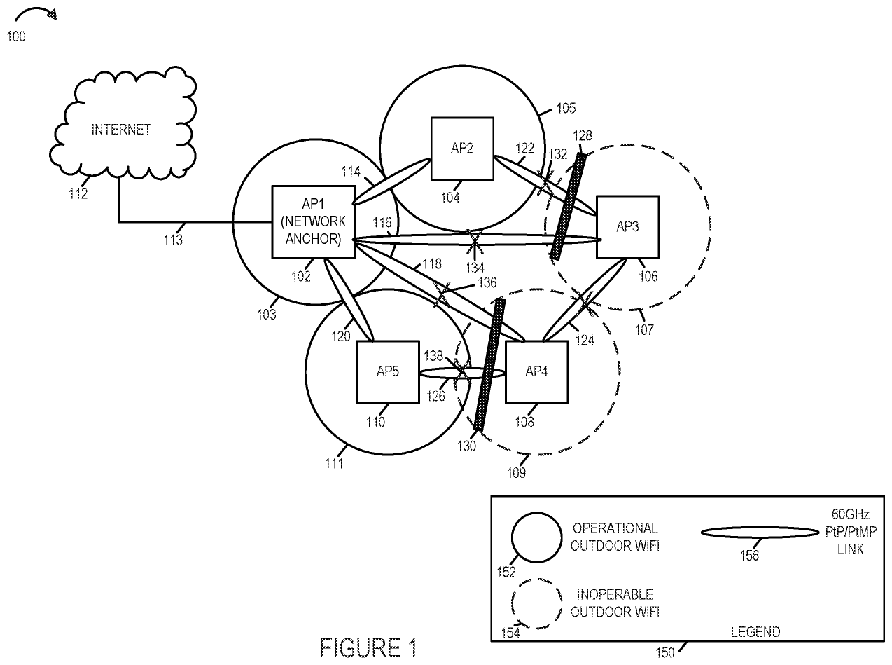

FIG. 2 is a drawing of an exemplary communications system in accordance with an exemplary embodiment.

FIG. 3 is a drawing of exemplary access point, which is AP3, illustrating features in accordance with various exemplary embodiments.

FIG. 4 is a drawing of exemplary access point, which is AP1, illustrating features in accordance with various exemplary embodiments.

FIG. 5 is a drawing which illustrates an example in which IP packets for an exemplary UE are being communicated via the system of FIG. 2, in which there are no detected failures with interconnect links or service regarding 60 GHz which could impact IP packet delivery to the UE.

FIG. 6 is a drawing which illustrates an example in which IP packets for an exemplary UE are being communicated via the system of FIG. 2, and there are detected failures with interconnect links or service regarding 60 GHz which could impact IP packet delivery to the UE.

FIG. 7A illustrates a first part of an example of 2 stage scheduler operation in AP3 during failover, e.g., corresponding to the example of FIG. 6.

FIG. 7B illustrates a second part of an example of 2 stage scheduler operation in AP3 during failover, e.g., corresponding to the example of FIG. 6.

FIG. 7 comprises the combination of FIG. 7A and FIG. 7B,.

FIG. 8A illustrates a first part of an example of 2 stage scheduler operation in AP1 during failover, e.g., corresponding to the example of FIG. 6.

FIG. 8B illustrates a second part of an example of 2 stage scheduler operation in AP1 during failover, e.g., corresponding to the example of FIG. 6.

FIG. 8 comprises the combination of FIG. 8A and FIG. 8B.

FIG. 9A is a first part of a flowchart illustrating the steps of an exemplary method of controlling an access point in accordance with one exemplary embodiment. FIG. 9B is a second part of a flowchart illustrating the steps of an exemplary method of controlling an access point in accordance with one exemplary embodiment.

FIG. 9C is a third part of a flowchart illustrating the steps of an exemplary method of controlling an access point in accordance with one exemplary embodiment.

FIG. 9D is a fourth part of a flowchart illustrating the steps of an exemplary method of controlling an access point in accordance with one exemplary embodiment.

FIG. 9E is a fifth part of a flowchart illustrating the steps of an exemplary method of controlling an access point in accordance with one exemplary embodiment.

FIG. 9 comprises the combination of FIG. 9A, 9B, 9C, 9D and 9E.

FIG. 10 illustrates the steps of a method of operating a multi-access network controller (MANC) in accordance with one exemplary embodiment.

FIG. 11 shows access point information corresponding to a first period of time that may be stored and used by a MANC.

FIG. 12 shows access point information corresponding to a second period of time that may be stored and used by a MANC.

FIG. 13 shows an exemplary access point (AP) that can be used as any one of the access points shown in the present application.

FIG. 14 shows an exemplary MANC which can be used as the MANC shown in any of the other figures.

### DETAILED DESCRIPTION

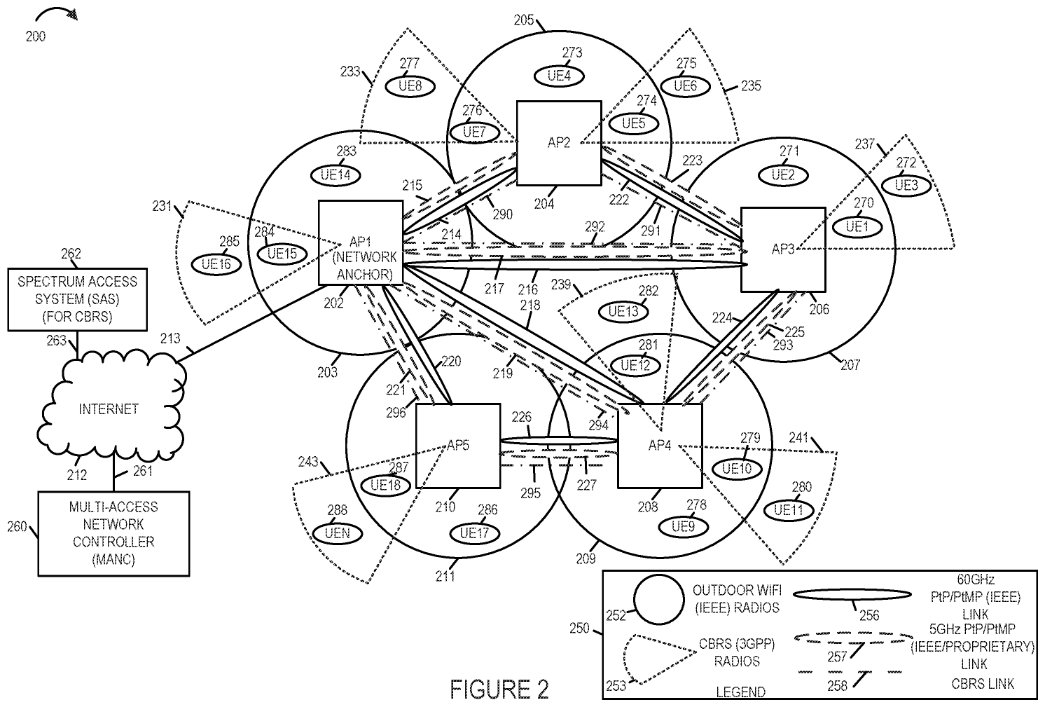

FIG. 2 is a drawing of an exemplary communications system 200 and a corresponding legend 250 in accordance with an exemplary embodiment. Communications system 100 includes a plurality of access points (APs) (AP1 202, AP2 204, AP3 206, AP4 208, AP5 210), a plurality of User Equipments (UEs) (UE1 270, UE2 271, UE3 272, UE4 273, UE5 274, UE6 275, UE7 276, UE8 277, UE9 278, UE10 279, UE11 280, UE12 281, UE13 282, UE14 283, UE15 284, UE16 285, UE17 286, UE18 287, . . . , UEN 288), a Multi-Access Network Controller (MANC) 260, a Spectrum Access System (SAS) 262, and Internet 112 coupled together. Legend 250 indicates: i) that solid line circles such as circle 252 represent outdoor WiFi (IEEE) radios coverage areas, ii) dotted line slices 253 (of a circle) represent exemplary CBRS (3GPP) radios coverage areas, iii) solid line ovals such as oval 256 represent 60 GHz PtP/PtMP (IEEE) links, iv) dashed line ovals such as oval 257 represent 5 GHz PtP/PtMP (IEEE/proprietary) links, and dash-dot lines such as dash-dot line 258 represent CBRS links, in exemplary system 200.

AP1 202, which is a network anchor, is coupled to the Internet 212 via communication link 213, e.g., a wireline or fiber optic communications link. AP1 202 is coupled to AP2 204 via 60 GHz PtP/PtMP link 214. AP1 202 is further coupled to AP2 204 via 5 GHz PtP/PtMP link 215. AP1 202 is further coupled to AP2 204 via CBRS link 290.

AP1 202 is coupled to AP3 206 via 60 GHz PtP/PtMP link 216. AP1 202 is further coupled to AP3 206 via 5 GHz PtP/PtMP link 217. AP1 202 is further coupled to AP3 206 via CBRS link 292.

AP1 202 is coupled to AP4 208 via 60 GHz PtP/PtMP link 218. AP1 202 is further coupled to AP4 208 via 5 GHz PtP/PtMP link 219. AP1 202 is further coupled to AP4 208 via CBRS link 294.

AP1 202 is coupled to AP5 210 via 60 GHz PtP/PtMP link 220. AP1 202 is further coupled to AP5 210 via 5 GHz PtP/PtMP link 221. AP1 202 is further coupled to AP5 210 via CBRS link 296.

AP2 204 is coupled to AP3 206 via 60 GHz PtP/PtMP link 222. AP2 204 is further coupled to AP3 206 via 5 GHz PtP/PtMP link 223. AP2 204 is further coupled to AP3 206 via CBRS link 291.

AP3 206 is coupled to AP4 208 via 60 GHz PtP/PtMP link 224. AP3 206 is further coupled to AP4 208 via 5 GHz PtP/PtMP link 225. AP3 206 is further coupled to AP4 208 via CBRS link 293.

AP4 208 is coupled to AP5 210 via 60 GHz PtP/PtMP link 226. AP4 208 is further coupled to AP5 210 via 5 GHz PtP/PtMP link 227. AP4 208 is further coupled to AP5 210 via CBRS link 295.

SAS 262, for supporting CBRS, is coupled to Internet 212 via link 263, e.g., a wireline or fiber optic link. Multi-access network controller (MANC) 260 is coupled to Internet 212 via link 261, e.g., a wireline or fiber optic link.

AP1 202 has a corresponding WiFi coverage area represented by solid line circle 203. AP1 202 has one or more corresponding CBRS coverage areas represented by exemplary CBRS coverage area 231. The CBRS coverage area 231 extends beyond the outer limits of the WiFi coverage area 203. AP1 202 includes a 60 GHz radio supporting 60 GHz WiFi communications with UEs and supporting 60 GHz PtP/PtMP links with other APs. AP1 202 further includes a 5 GHz radio supporting 5 GHz WiFi communications with UEs and supporting 5 GHz PtP/PtMP links with other APs. AP1 202 further includes a CBRS radio supporting CBRS communications with UEs and supporting CBRS links with other APs.

AP2 204 has a corresponding WiFi coverage area represented by solid line circle 205. AP2 204 has one or more corresponding CBRS coverage areas represented by exemplary CBRS coverage areas 233, 235. The CBRS coverage areas 233, 235 each extend beyond the outer limits of the WiFi coverage area 205. AP2 204 includes a 60 GHz radio supporting 60 GHz WiFi communications with UEs and supporting 60 GHz PtP/PtMP links with other APs. AP2 204 further includes a 5 GHz radio supporting 5 GHz WiFi communications with UEs and supporting 5 GHz PtP/PtMP links with other APs. AP2 204 further includes a CBRS radio supporting CBRS communications with UEs and supporting CBRS links with other APs.

AP3 206 has a corresponding WiFi coverage area represented by solid line circle 207. AP3 206 has one or more corresponding CBRS coverage areas represented by exemplary CBRS coverage area 237. The CBRS coverage areas 237 extends beyond the outer limits of the WiFi coverage area 207. AP3 206 includes a 60GHz radio supporting 60 GHz WiFi communications with UEs and supporting 60 GHz PtP/PtMP links with other APs. AP3 206 further includes a 5 GHz radio supporting 5GHz WiFi communications with UEs and supporting 5 GHz PtP/PtMP links with other APs. AP3 206 further includes a CBRS radio supporting CBRS communications with UEs and supporting CBRS links with other APs.

AP4 208 has a corresponding WiFi coverage area represented by solid line circle 209. AP4 208 has one or more corresponding CBRS coverage areas represented by exemplary CBRS coverage areas 239, 241. The CBRS coverage areas 239, 241 each extends beyond the outer limits of the WiFi coverage area 209. AP4 208 includes a 60 GHz radio supporting 60 GHz WiFi communications with UEs and supporting 60 GHz PtP/PtMP links with other APs. AP4 208 further includes a 5 GHz radio supporting 5 GHz WiFi communications with UEs and supporting 5 GHz PtP/PtMP links with other APs. AP4 208 further includes a CBRS radio supporting CBRS communications with UEs and supporting CBRS links with other APs.

AP5 210 has a corresponding WiFi coverage area represented by solid line circle 211. AP5 210 has one or more corresponding CBRS coverage areas represented by exemplary CBRS coverage area 243. The CBRS coverage area 243 extends beyond the outer limits of the WiFi coverage area 211. AP5 210 includes a 60 GHz radio supporting 60 GHz WiFi communications with UEs and supporting 60 GHz PtP/PtMP links with other APs. AP5 210 further includes a 5 GHz radio supporting 5 GHz WiFi communications with UEs and supporting 5 GHz PtP/PtMP links with other APs. AP5 210 further includes a CBRS radio supporting CBRS communications with UEs and supporting CBRS links with other APs.

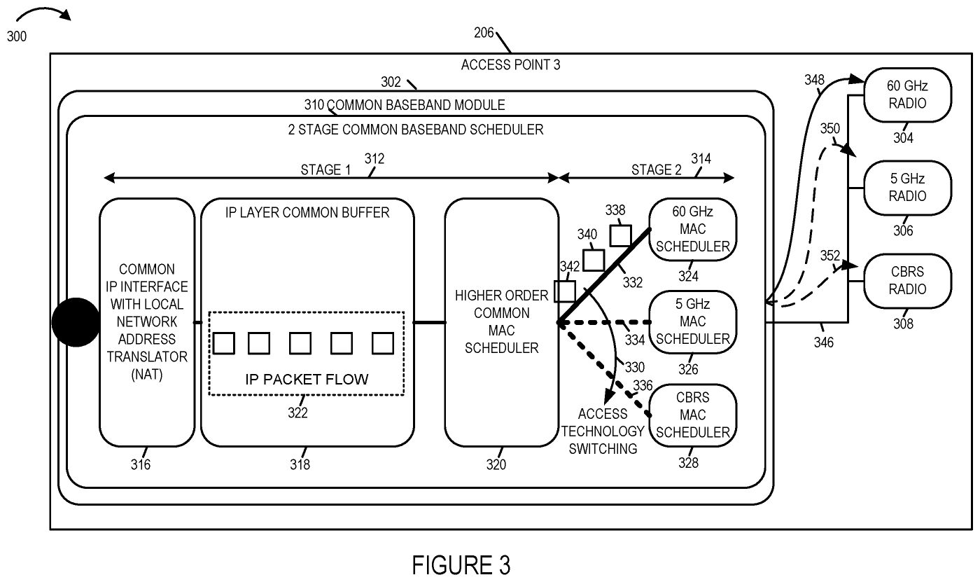

FIG. 3 is a drawing 300 of exemplary access point, which is AP3 206, illustrating features in accordance with various exemplary embodiments. AP3 206 includes a common baseband module 302 and a plurality of radios (60 GHz radio 304, 5 GHz radio 306, and CBRS radio 308) coupled together via link 346. The common baseband module 302 includes a 2-stage baseband scheduler 310 including a stage 1 portion 312 and a stage 2 portion 314. Stage 1 portion 312 includes a common IP interface with a local network address translator (NAT) 316, an IP layer common buffer 318, and a higher order common MAC scheduler 320 coupled together as shown. Stage 2 portion 314 includes access technology switching 330 and a plurality of access technology specific MAC schedulers (60 GHz MAC scheduler 324, 5 GHz MAC scheduler 326, and CBRS MAC scheduler 328).

Stage 1 312 acts as a primary interface to MANC 260 to support redundancy and retransmission during access failover. The common IP interface 316 to egress and ingress traffic maintains the singular IP address. This use of a common IP interface 316 eliminates the need for IP reconfiguration during access mechanism switching.

The IP layer common buffer 318 includes an IP packet flow 322 including a plurality of IP packets. The higher order common MAC scheduler 320 schedules each packet from the IP packet flow 322 to one of the individual technology specific MAC schedulers (324, 324, 328). Exemplary IP packets 338, 340, 342, shown along switched path 332 have been scheduled by higher order common scheduler 320 to 60 GHz MAC scheduler 324, which will subsequently schedule the received IP packet 338, 340, 342 to be sent via path 348 to 60 GHz radio 304 to be transmitted by 60 GHz radio 304.

Access technology switching 330 controls the switching from the output of higher order common MAC scheduler 320 for delivery of an IP packet along alternative paths (332, 334, 336), corresponding to the alternative access technology specific MAC schedulers (60 GHz MAC scheduler 324, 5 GHz MAC scheduler 326, 328 MAC scheduler 328), respectively, which may be selected.

In this example, the packets 338, 340, 342 are being shown as being sent via path 332 and 348. Alternatively, the packets 338, 340, 342 could have been sent via path 334 and 350 or via path 336 and 352, e.g., depending upon which access technology was selected.

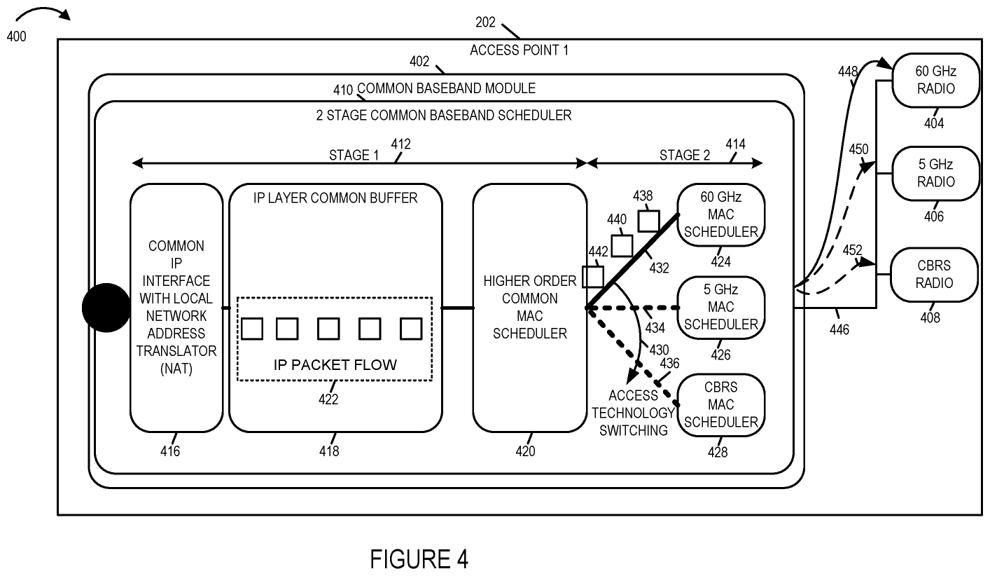

FIG. 4 is a drawing 400 of exemplary access point, which is AP1 202, illustrating features in accordance with various exemplary embodiments. AP1 202 includes a common baseband module 402 and a plurality of radios (60 GHz radio 404, 5 GHz radio 406, and CBRS radio 408) coupled together via link 446. The common baseband module 402 includes a 2-stage baseband scheduler 410 including a stage 1 portion 412 and a stage 2 portion 414. Stage 1 portion 412 includes a common IP interface with a local network address translator (NAT) 416, an IP layer common buffer 418, and a higher order common MAC scheduler 420 coupled together as shown. Stage 2 portion 414 includes access technology switching 430 and a plurality of access technology specific MAC schedulers (60 GHz MAC scheduler 424, 5 GHz MAC scheduler 426, and CBRS MAC scheduler 428).

Stage 1 412 acts as a primary interface to MANC 260 to support redundancy and retransmission during access failover. The common IP interface 416 to egress and ingress traffic maintains the singular IP address. This use of a common IP interface 416 eliminates the need for IP reconfiguration during access mechanism switching.

The IP layer common buffer 418 includes an IP packet flow 422 including a plurality of IP packets. The higher order common MAC scheduler 430 schedules each packet from the IP packet flow 422 to one of the individual technology specific MAC schedulers (424, 426, 428). Exemplary IP packets 438, 440, 442, shown along switched path 432 have been scheduled by higher order common scheduler 420 to 60 GHz MAC scheduler 424, which will subsequently schedule the received IP packet 438, 440, 442 to be sent via path 448 to 60 GHz radio 404 to be transmitted by 60 GHz radio 404.

Access technology switching 430 controls the switching from the output of higher order common MAC scheduler 420 for delivery of an IP packet along alternative paths (432, 434, 436), corresponding to the alternative access technology specific MAC schedulers (60 GHz MAC scheduler 424, 5 GHz MAC scheduler 426, 428 MAC scheduler 428), respectively, which may be selected.

In this example, the packets 438, 440, 442 are being shown as being sent via path 432 and 448. Alternatively, the packets 438, 440, 442 could have been sent via path 434 and 450 or via path 436 and 452, e.g., depending upon which access technology was selected.

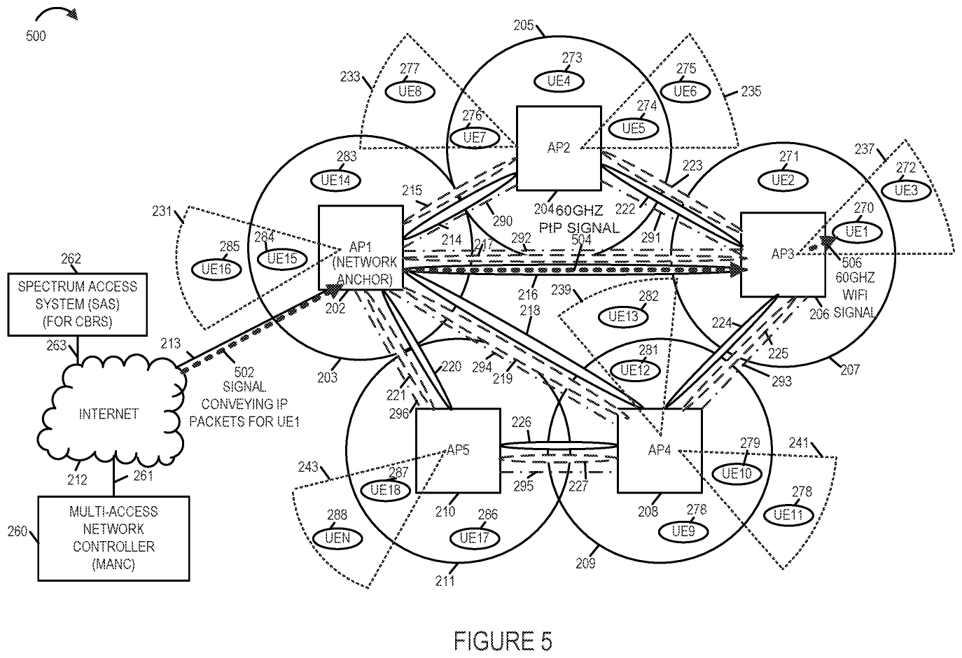

FIG. 5 is a drawing 500 which illustrates an example in which IP packets for UE1 270 are being communicated via system 200, in which there are no detected failures with interconnect links or service regarding 60 GHz which could impact IP packet delivery to UE1 270. AP1 202, which is a network anchor AP, receives signals 502 conveying IP packets for UE1 270 over communications link 213. AP1 202 stores the received IP packets in its IP layer common buffer 418. The higher order common MAC scheduler 420 in AP1 202 directs the packets to its 60 GHz MAC scheduler 424, which schedules the IP packets for transmission via its 60 GHz radio 404. AP1 202 generates and sends, e.g., transmits via the 60 GHz radio 404, 60 GHz PtP signal 504, conveying the received IP packets for UE1, over 60 GHz PtP link 216 to AP3 206. AP3 206 receives the signals 504 and recovers the IP packets, e.g., storing the received packets in its IP layer common buffer 318. The higher order common MAC scheduler 320 in AP3 206 directs the packets to its 60 GHz MAC scheduler 324, which schedules the IP packets for transmission via its 60 GHz radio 304. AP3 206 generates and sends 60 GHz WiFi signals 506 to UE1 270, which successfully receives signals 506 and recovers the communicated IP packets.

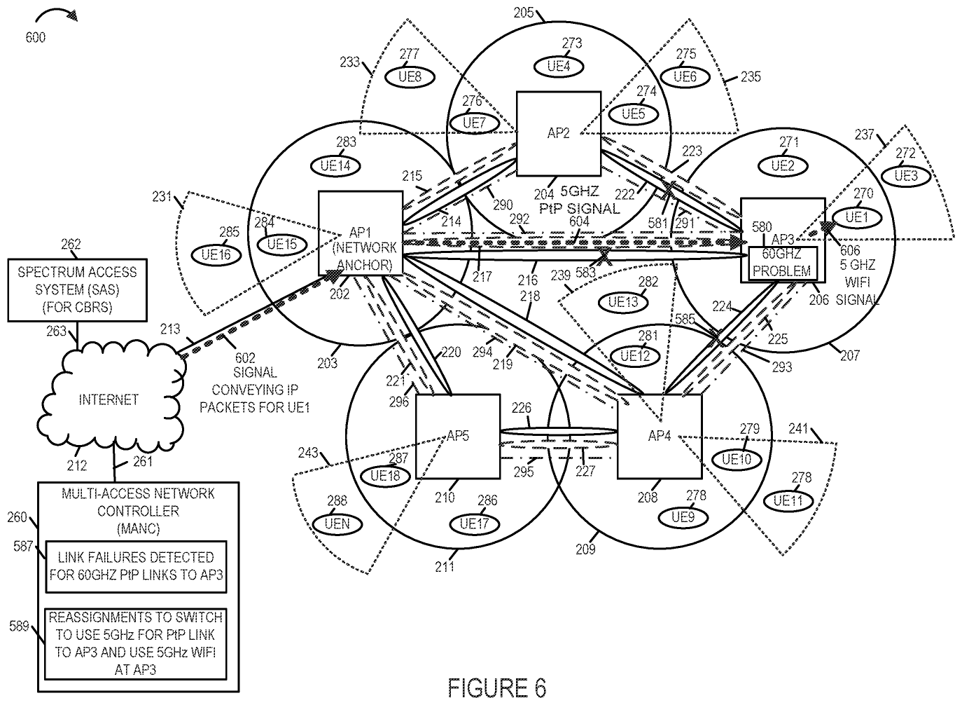

FIG. 6 is a drawing 600 which illustrates an example in which IP packets for UE1 270 are being communicated via system 200, and there are detected failures with interconnect links or service regarding 60 GHz which could impact IP packet delivery to UE1 270. In this example, there is a problem with regard to 60 GHz for AP3 206, as indicated in block 580. As a result of the 60 GHz problem, link failures occur on 60 GHz PtP links 216, 222, and 224, as indicated by Xs 583, 581, and 585, respectively. The link failures detected for 60 GHz PtP links to AP3 are recognized by the MANC 260, as indicated by block 587. The MANC 260 performs reassignments and communicates reassignments to switch to use 5 GHz for the PtP link to AP3 and to switch to use 5 GHz WiFi at AP3, as indicated by block 589, as indicated by block 589. In some embodiments, the MANC 260 commands AP3 206 to transition into a failure mode, and as part of failure mode operation, AP3 206 uses alternative radio(s), e.g., the 5 GHz radio and/or the CBRS radio instead of the 60 GHz radio for communications.

AP1 202, which is a network anchor AP, receives signals 602 conveying IP packets for UE1 270 over communications link 213. AP1 202 stores the received IP packets in its IP layer common buffer 418. The higher order common MAC scheduler 420 in AP1 202 directs the packets to its 5 GHz MAC scheduler 426, which schedules the IP packets for transmission via its 5 GHz radio 406. AP1 202 generates and sends, e.g., transmits via the 5 GHz radio 406, 5 GHz PtP signal 604, conveying the received IP packets for UE1, over 5 GHz PtP link 217 to AP3 206. AP3 206 receives the signals 604 and recovers the IP packets, e.g., storing the received packets in its IP layer common buffer 318. The higher order common MAC scheduler 320 in AP3 206 directs the packets to its 5 GHz MAC scheduler 326, which schedules the IP packets for transmission via its 5 GHz radio 306. AP3 206 generates and sends 5 GHz WiFi signals 606 to UE1 270, which successfully receives signals 606 and recovers the communicated IP packets.

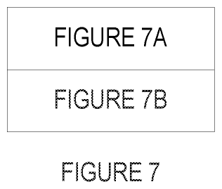

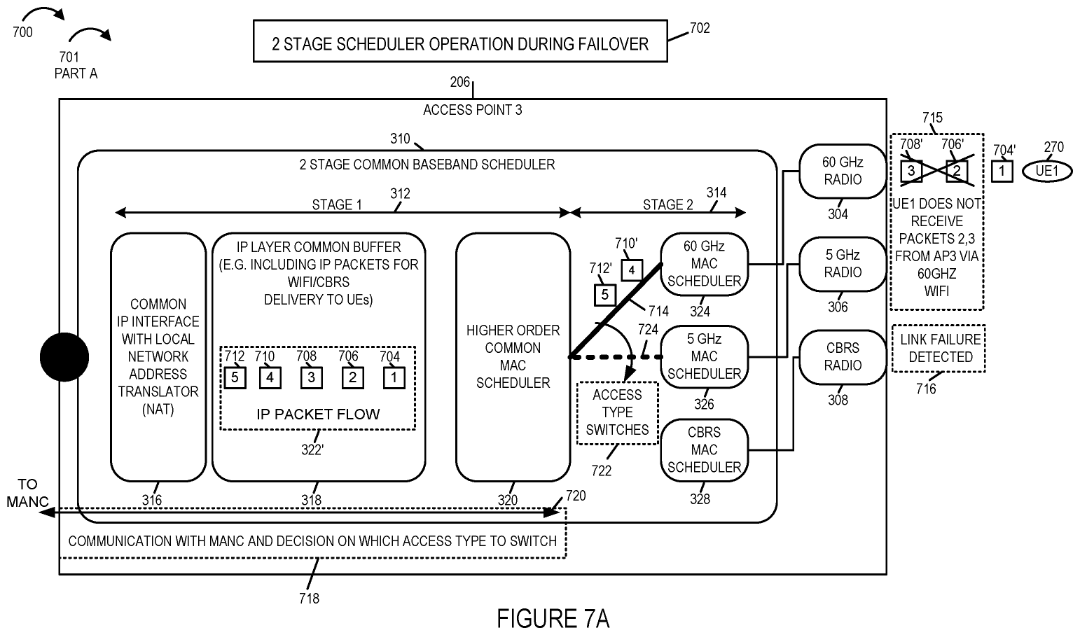

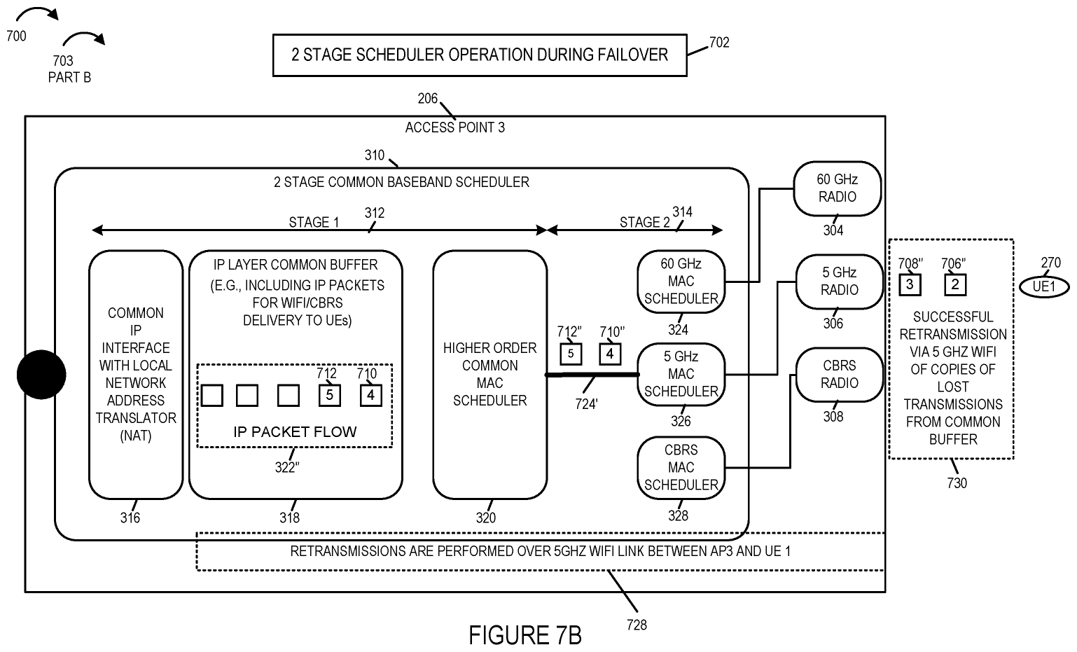

FIG. 7, comprising the combination of FIG. 7A and FIG. 7B, is a drawing 700 including Part A 701 and Part B 703, which illustrates an example of 2 stage scheduler operation in AP3 206 during failover, as indicated by title box 702, e.g., corresponding to the example of FIG. 6. In FIG. 7A, the IP layer common buffer 318 of access point 3 206 includes IP packet flow 322′, which includes IP packet 1 704, IP packet 2 706, IP packet 3 708, IP packet 4 710 and IP packet 5 712. Consider for this example, that the IP packets (IP packet 1 704, IP packet 2 706, IP packet 3 708, IP packet 4 710 and IP packet 5 712) are directed to UE1 270, and that access point 3 206 is operating in a normal mode of operation, and that UE1 270 is within range of 60 GHz radio 304. Higher order common MAC scheduler 320 determines to assign the packets to the 60 GHz WiFi network, assigns the packets to the 60 GHz MAC scheduler 324 and starts sending the packets via connection 714 to the 60 GHz MAC scheduler 324. The 60 GHz MAC scheduler 324 schedules the received packets for transmission via its 60 GHz radio 304, which generates and transmits 60 GHz WiFi signals communicating the IP packets toward UE1 270. In this example, UE1 270 receives 60 GHz WiFi signals successfully recovers IP packet 1, as indicated by recovered IP packet 1 704′. UE1 270 does not receive IP packets 2 and 3 from AP3 206 via 60 GHz WiFi, as indicated by IP packet 2 706′ with an X, and IP packet 3′ 708′ with an X, as indicated in box 715. IP packet 4 710′ and IP packet 5 710′ were in the pipeline, intended to be transmitted by 60 GHz radio 304, but were not yet transmitted.

Link failure is detected e.g., by AP3 206, as indicated by block 716, e.g., due to AP3 206 not receiving ACKs, e.g., in a predetermined time, in response to previously transmitted IP packet 2 and IP packet 3. AP3 206 communicates with the MANC, e.g., MANC 260, e.g., sending information indicating failure has been detected over its 60 GHz WiFi, and receiving a response indicating that the AP3 206 should switch to another access type, e.g., switch to use the 5 GHz radio for retransmission, as indicated by signaling 720 in block 718. In step 722 the higher order common MAC scheduler 320 switches to assigning and sending the packets, to the 5 GHz MAC scheduler 326, along path 724.

In FIG. 7B, it may be observed that the higher order common MAC scheduler 320 is assigning and sending the packets, which are being re-transmitted, via path 724′ to the 5 GHz MAC scheduler 326 for subsequent scheduling and transmission via 5 GHz radio 306. IP packet 2 and IP packet 3 have been successfully communicated via 5GHz WiFi signals to UE1 270, as indicated by packet 2 706″ and packet 3 708″ in block 730 next to UE1 270. After a packet is successfully recovered by the UE1 270, the UE1 270 sends an Ack to AP3 206 indicating success, and the AP3 206 removes the packet from its IP layer common buffer 318.

At this point in time, since packets 2 and 3 have been successfully communicated to UE1 270, those packets have been removed, e.g., deleted, from common IP buffer 318. IP buffer 318 includes packet flow 322″ which still includes IP packet 4 710 and IP packet 5 712, since those 2 packets are still in the pipeline to be retransmitted, as indicated by packet 4 710″ and packet 5 712″ which are shown along path 724′ between the higher order common MAC scheduler 320 and the 5 GHz MAC scheduler 326.

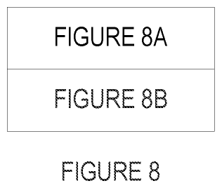

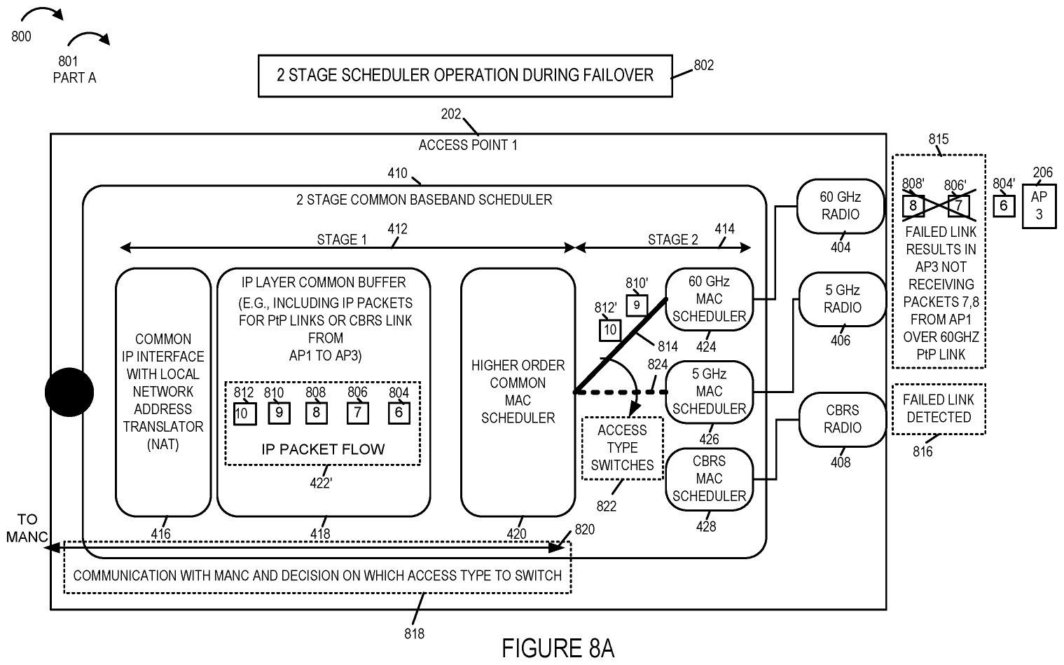

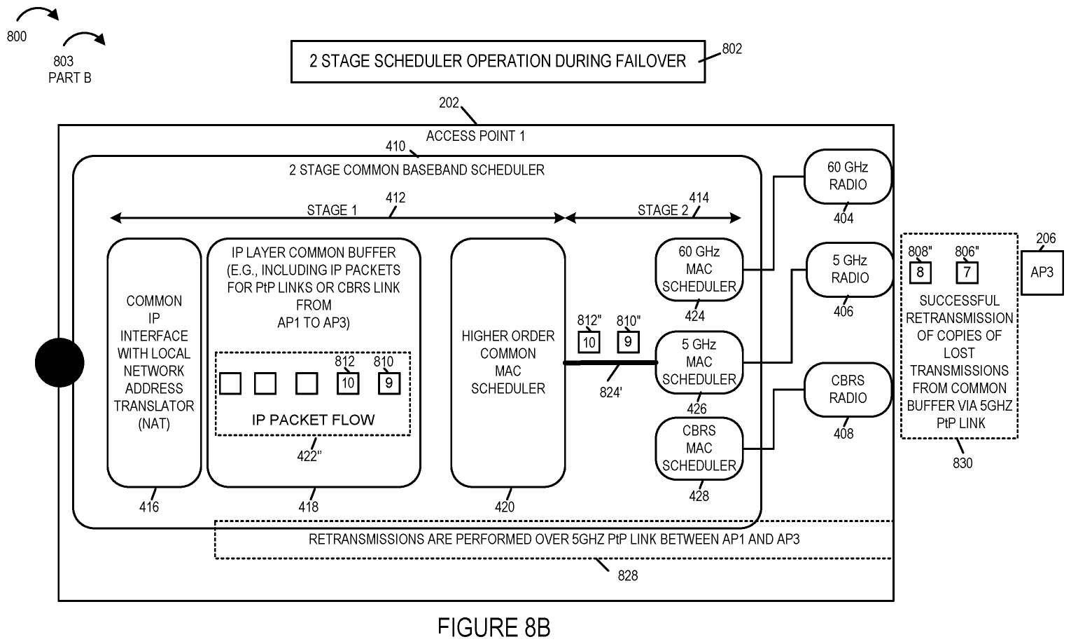

FIG. 8, comprising the combination of FIG. 8A and FIG. 8B, is a drawing 800 including Part A 801 and Part B 803, which illustrates an example of 2 stage scheduler operation in AP1 202 during failover, as indicated by title box 802, e.g., corresponding to the example of FIG. 6. In FIG. 8A, the IP layer common buffer 418 of access point 1 202 includes IP packet flow 422′, which includes IP packet 6 804, IP packet 7 806, IP packet 8 808, IP packet 9 810 and IP packet 10 812. Consider for this example, that the IP packets (IP packet 6 804, IP packet 7 806, IP packet 8 808, IP packet 8 810 and IP packet 10 812) are directed to AP3 206, and that access point 1 202 is operating in a normal mode of operation, and that the 60 GHz PtP link 216 is operational and is being used. Higher order common MAC scheduler 420 determines to assign the packets directed to AP3 206 to the 60 GHz PtP link 216, assigns the packets to the 60 GHz MAC scheduler 424 and starts sending the packets via connection 814 to the 60 GHz MAC scheduler 424. The 60 GHz MAC scheduler 424 schedules the received packets for transmission via its 60 GHz radio 404, which generates and transmits 60 GHz PtP signals communicating the IP packets via 60 GHz PtP link 216 toward AP3 206. In this example, AP3 206 receives 60 GHz PtP signals successfully recovers IP packet 6, as indicated by recovered IP packet 6 804′. AP3 206 does not receive IP packets 7 and 8 from AP1 202 via 60 GHz PtP link 216, as indicated by IP packet 7 806′ with an X, and IP packet 8 808′ with an X, as indicated in box 815. IP packet 9 810′ and IP packet 10 810′ were in the pipeline, intended to be transmitted by 60 GHz radio, but were not yet transmitted.

Link failure is detected e.g., by AP1 202, as indicated by block 816, e.g., due to AP1 202 not receiving ACKs, e.g., in a predetermined time, in response to previously transmitted IP packet 7 and IP packet 8. AP1 202 communicates with the MANC, e.g., MANC 260, e.g., sending information indicating failure has been detected over its 60 GHz PtP link, and receiving a response indicating that the AP1 202 should switch to another access type, e.g., switch to use the 5 GHz radio for retransmission, as indicated by signaling 820 in block 818. In step 822 the higher order common MAC scheduler switches to assigning and sending the packets, to the 5 GHz MAC scheduler 426, along path 824.

In FIG. 8B, it may be observed that the higher order common MAC scheduler 420 is assigning and sending the packets, which are being re-transmitted, via path 824′ to the 5 GHz MAC scheduler 426 for subsequent scheduling and transmission via 5 GHz radio 406. IP packet 7 and IP packet 8 have been successfully communicated via 5 GHz PtP signals over 5 GHz PtP link 217 to AP3 206, as indicated by packet 7 806″ and packet 8 808″ in block 830 next to AP3 206. After a packet is successfully recovered by AP3 206, AP3 206 sends an Ack to AP1 202 indicating success, and the AP1 202 removes the packet from its IP layer common buffer 418.

At this point in time, since packets 7 and 8 have been successfully communicated via 5 GHz PtP link 217 to AP3 206, those packets have been removed, e.g., deleted, from common IP buffer 418. IP buffer 418 includes packet flow 422″ which still includes IP packet 9 810 and IP packet 10 812, since those 2 packets are still in the pipeline to be retransmitted, as indicated by packet 9 810″ and packet 10 812″ which are shown along path 824′ between the higher order common MAC scheduler 420 and the 5 GHz MAC scheduler 426.

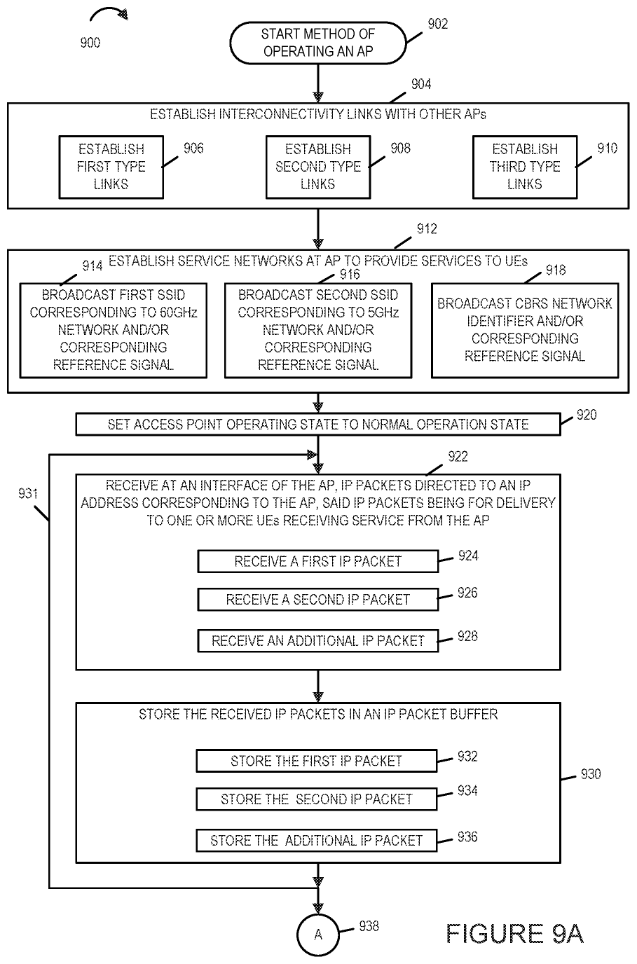

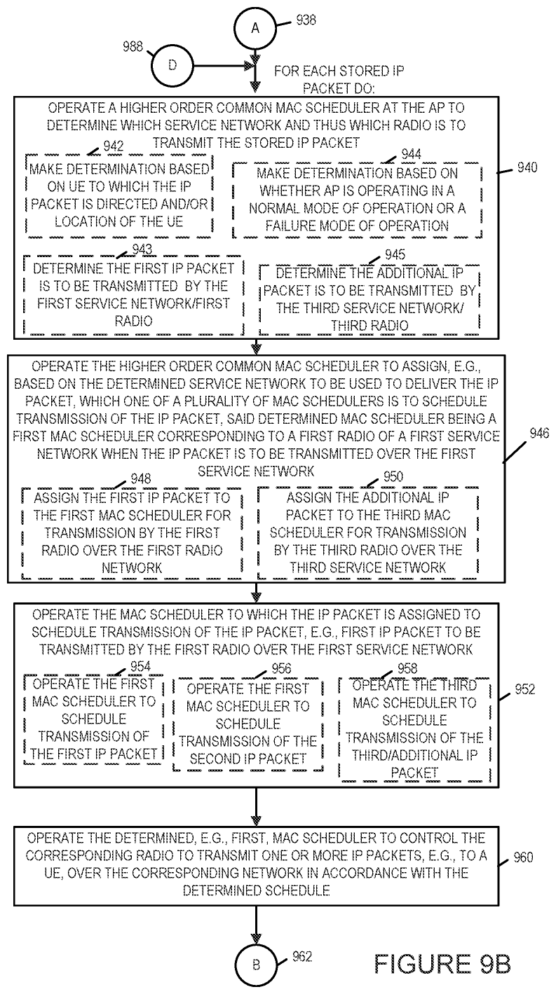

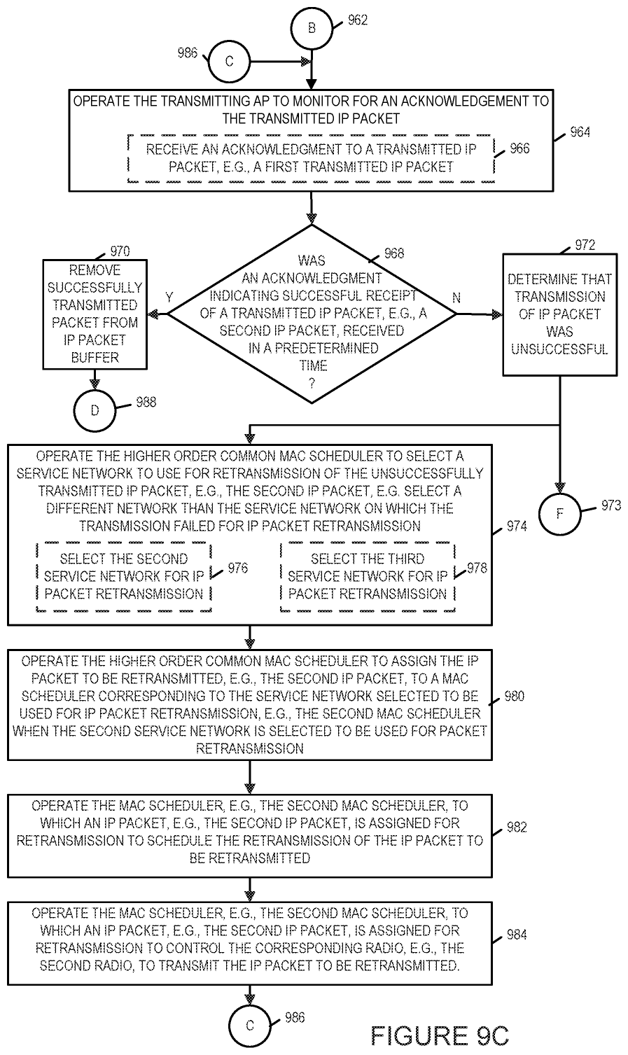

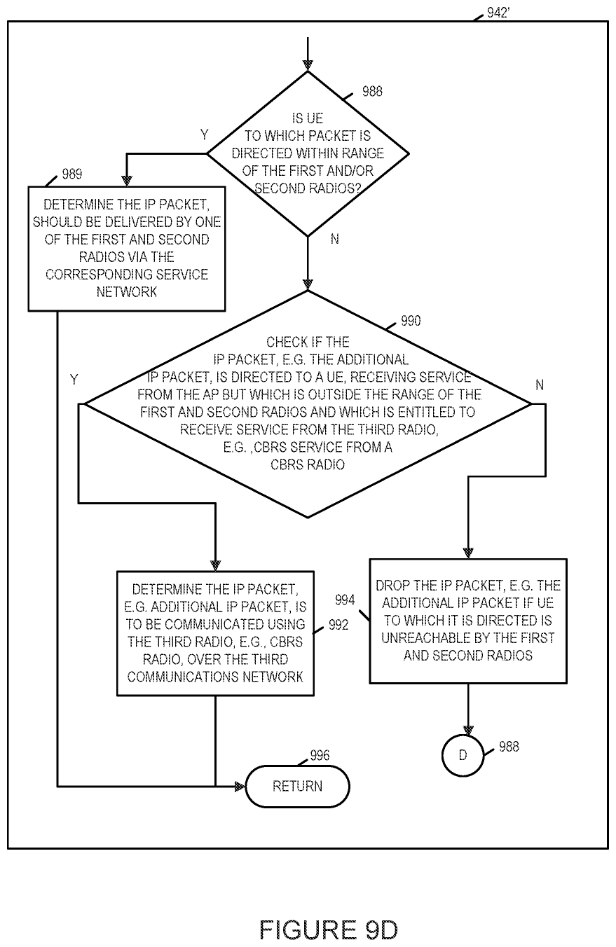

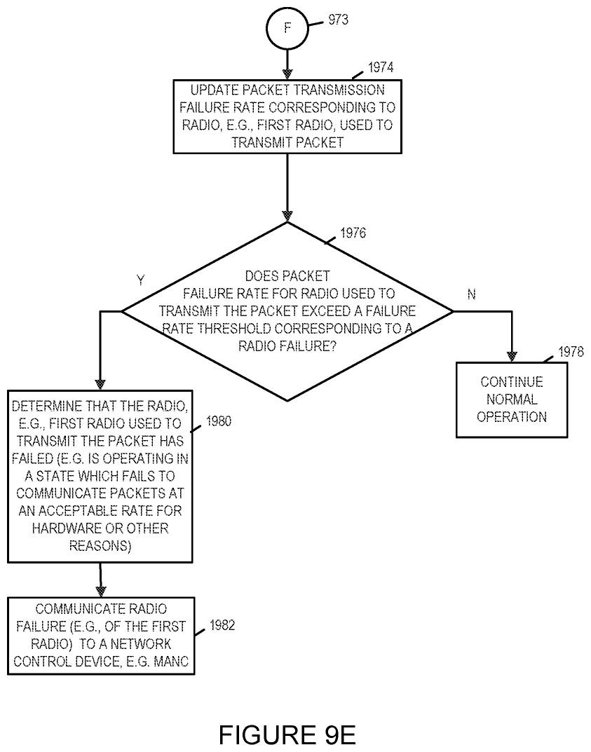

FIG. 9, which corresponds to combination of FIGS. 9A, 9B, 9C, 9D, and 9E, is a flowchart 900 showing the steps of operating an access point in accordance with one exemplary embodiment. The method can be implemented by one, more of all of the APs described in the present application. For purposes of explaining the exemplary method of FIG. 9 it will be assumed that access point 3 206 shown in FIG. 3 is implementing the method 900. The method starts in start step 902 with the access point 206 being powered on and beginning operation of its radios 304, 306, 308, common IP interface 316, IP layer common buffer 318, higher order MAC schedule 320, MAC schedules 324, 326, 328 and radios 324, 326, 328. As will be discussed below the common IP interface 316 is used to receive IP packets directed to the IP address of the AP 206 while the IP layer common buffer 318 is used to store the IP packets for transmission by one or more of the radios 304, 306, 308. The higher order common MAC scheduler 420 assigns the packets in the buffer 318 to one of the radios 304, 306 and 308 for transmission by assigning the packets, e.g., on per packet basis, to one of the MAC schedulers 324, 326 or 328. Each MAC scheduler 324, 326, 328 corresponds to a different one of the radios 304, 306, 308, respectively. The 60 GHz MAC scheduler 324 corresponds to the 60 GHz radio 304 and schedules transmissions of packets over the 60 GHz service network. The 5 GHz MAC scheduler 326 corresponds to the 5 GHz radio 306 and schedules packet transmission over the 5 GHz service network. The CBRS MAC schedule 328 corresponds to the CBRS radio 308 and schedules the transmission of the packets over the CBRS service network. The access point 206 can receive packets directed to the IP address of the common interface 316 from any one of a plurality of interconnectivity links with different interconnectivity links being supported by different ones of the 60 GHz radio 304, 5 GHz radio 306 and CBRS radio 308. As should be appreciated when a radio 304, 306, 308 fails due to a hardware issue, both the interconnectivity links and service network corresponding to the radio will be lost. Thus, loss of all interconnectivity links to a radio 304, 306, 308 in some embodiments is an indication of a radio failure at the AP 206. The service network corresponding to a radio can fail due to hardware issues, interference and/or blockage of the radio signal path by an obstruction. A service network failure is detected/declared by a radio 304, 306, 308 when a packet transmission failure rate exceeds a service network failure rate used to determine failure of the service network. The detection of a radio network failure (e.g., checking of a packet failure rate and declaration of a service network failure) can be, and sometimes is, performed by the higher order common MAC scheduler 320 which is notified of packet transmission failure and is responsible for controlling packet retransmissions and/or by the individual radios 304, 306, 308 themselves. The AP 206 reports a detected service network failure and/or restoration of a service network to the MANC, e.g., MANC 260, so that it is aware of the situation and can make a decision as to what mode of operation the access point 206 should be controlled to operate in. The MANC will control the AP 206, e.g., through the sending of control messages, to switch between normal and failure modes of operation as appropriate based on interconnectivity link status and/or reported service network status.

While various general elements and operations of the access point have been discussed, their implementation as part of the method 900 will now be discussed in greater detail.

With the AP 206 having been powered on and starting operation in step 902 operation proceeds to step 904 in which interconnectivity links with other APs 202, 204, 208, 210 are established. Interconnectivity links are established using each of the available radios 304, 306, 308. Thus, in some embodiments, step 902 includes sub-steps 906, 908, 910. In step 906 first type (e.g., 60 GHz) interconnectivity links, e.g., 60 GHz PtP links, are established between the APs. In step 908 second type (e.g., 5 GHz GHz) interconnectivity links, e.g., 5 GHz PtP links, are established between the APs. In step 910 third type (e.g., CBRS) interconnectivity links, are established between the APs. Thus in various embodiments WiFi interconnectivity links and CBRS interconnectivity links are supported with each type of interconnectivity link corresponding to a different frequency band and capable of supporting a different amount of bandwidth. The bandwidth supported by the 60 GHz interconnectivity links and service network is normally the highest with the 5 GHz supporting a lower bandwidth and the CBRS links/service network supporting the lowest bandwidth. As should be appreciated when the 60 GHz links/network fails it can be desirable to use the 5 GHz alone or in combination with the CBRS network to support UEs receiving service but even with such use some packets may need to be dropped if the 60 GHz links/service network was fully loaded before failure of the 60 GHz network.

With the interconnectivity links having been established in step 904, operation proceeds to step 912, in which the AP 206 establishes service networks using the available radios 304, 306, 308 to provide service to UEs thereby allowing the UEs to receive data packets from the Internet and send packets to the Internet via AP 206. A different service network is established in step 912 using each of the available radios. Step 912 includes in some embodiments step 914, 916 and 918. In step 914 the AP 206 establishes a first, e.g., 60 GHz, WiFi service network and begins broadcasting, e.g., using the first radio 304, a first SSID corresponding to the 60 GHz network and/or broadcasting timing or other reference signals corresponding to the first service network. In step 916 the AP 206 establishes a second, e.g., 5 GHz, WiFi service network and begins broadcasting, e.g., using the second radio 306, a second SSID corresponding to the 5 GHz network and/or broadcasting timing or other reference signals corresponding to the second service network. In step 918 the AP 206 establishes a third, e.g., CBRS, service network and begins broadcasting, e.g., using the third radio 308, a CBRS identifier and/or corresponding CBRS reference signals.

With the service networks having been established in step 912, AP operation proceeds to step 920 wherein the access point is set, e.g., initially, to operate in a normal state of operation. Operation proceeds from step 920 to steps 922 and 930 which are shown sequentially but in some embodiments which are implemented in parallel, e.g., on an ongoing basis, as represented by the arrow 931 returning from the bottom of step 930 to the top of step 922 to indicate that IP packets can be received and stored on an ongoing basis.

In step 922 the AP receives at the common IP interface 316 IP packets directed to the IP address corresponding the AP 206. The packets can be received via any of the interconnectivity links with the AP or in the case of an anchor AP from the Internet. The packets will in many cases be packets directed to a UE receiving service from the AP with the AP potentially providing service to multiple UEs 270, 271, 272 at the same time. In step 924 a first IP packet is received, in step 926 a second IP packet is received and in step 928 a third IP packet is received. In step 922 three packets are shown being received in steps 924, 266, 928 but any number of packets may be received over time with the AP receiving the packets as they are delivered to the AP 206. The third packet is referred to as an additional IP packet out of convenience and to provide support for language used elsewhere in the application.

The received packets are stored in the common IP packet buffer 318 pending delivery via a radio link to the UE to which the packet is directed. The packets are stored in the buffer 318 until successfully being delivered or they are dropped due to timing out or because the higher order common MAC scheduler 320 determines that the limited bandwidth and/or priority level service of the UE to which the packet is directed makes it unlikely that the packet will be able to be delivered in a reasonable or predetermined amount of time.

In step 932 the first received packet is stored in the buffer 318. In step 934 the second packet is stored in the buffer 318, and in step 936 the additional IP packet is stored in the buffer 318. As noted above, packets are received and stored on an ongoing basis but processing also continues so that the received and stored packets can be delivered to UEs. Processing proceeds from step 930 via connecting node A 938 to step 940 shown in FIG. 9B. Step 940 is the beginning of processing which is performed for each received packet which is stored in the IP packet buffer 318.

In step 940 the higher order common MAC schedule 320 at the AP 206 determines which service network and thus which radio is to transmit the stored IP packet for which step 940 is being performed. This determination can depend on various factors such as the UE to which the packet is directed, the service priority level of the UE to which the packet is directed, the mode of operation (normal or failure mode) the AP 206 is operating in and/or other factors such as the packet load and bandwidth available for transmission at the AP 206 when the determination is being made in step 940. Step 940, in some embodiments, includes step 942 of making the service network/radio determination based on the UE to which the packet is directed and/or the location of the UE to which the packet is directed. For example, if the UE is a UE entitled to receive CBRS service and the UE to which the packet is directed is out of WiFi range but within CBRS range of the AP 206 (see, e.g., UE3 272), the CBRS radio 308 may be selected in step 940 to be used to deliver the packet. However, if the UE (consider for example UE1 270) were in WiFi range, a WiFi radio, e.g., radio 1 324 or radio 2 326 would be selected during normal operation to deliver the packet to the UE. The delivery of a packet to a UE outside of WiFi range via CBRS is sometimes referred to as extended range service. In some embodiments based on the determination made in step 942, UE 270 will receive a packet directed to the first UE 270 via the first radio 304 while the third UE 272 will receive a packet directed to the third UE via CBRS radio 308 when positioned as shown in FIG. 2.

FIG. 9D shows the steps of a method 942′ which can be used as step 942 which relates to the higher order MAC scheduler 320 determining service network and radio that is to be used to transmit a stored packet based on the UE to which the packet is directed and the location of the UE to which the packet is directed. Reference will now be made to FIG. 9D and step 942′ which can be used as step 942 of FIG. 9B.

Exemplary step 942′ involves checking in step 988 if the UE to which the packet is directed is within range of the first and/or second radios, e.g., WiFi radios and thus can be serviced without having to resort to the longer range CBRS radio, e.g., the third radio 308. If in step 988 it is determined that the UE to which the packet is directed is within range of one of the first and second radios 304, 306, operation proceeds to step 989, in which it is determined that the IP packet should be delivered by one of the first and second radios via the corresponding radio and service network. This will normally, and sometimes does, involve assigning the packet to be transmitted by the first, 60 GHz radio 304 during normal operation. With the packet being assigned for transmission to one of the first and second radios and corresponding networks in step 989, operation proceeds to return step 996 where operation will continue from step 942 of FIG. 9B to the next step in FIG. 9B.

If in step 988 it is determined that the packet cannot be transmitted by the first and/or second radio, e.g., due to the UE to which the packet is directed being out of range of these radios, operation proceeds from step 988 to step 990 of FIG. 9D.

In step 990 a check is made to determine if the IP packet to be transmitted, e.g., the additional IP packet for example, is directed to a UE receiving service from the AP 206 (indicating that it is reachable from the AP 206), which is outside the range of the first and second radios and that that the UE is entitled to receive service from the third radio, e.g., CBRS radio. In the check is positive, operation will proceed to step 992, in which it is determined that the packet should be transmitted by the third (e.g., CBRS) radio, and the packet will be assigned for transmission by the third radio over the third communications network. This determination in step 990 is based on information about a service level to which the UE is entitled. For example, a UE may be entitled to CBRS service based on a service plan entitling it to a service level that provides such service. In other cases, a UE might not be entitled to CBRS service because of a service plan to which the UE subscribes being limited to WiFi service. In step 990 if the UE is entitled to receive service from the third radio 308 and is outside the range of the first and second radios 304, 306, operation will proceed from step 990 to step 992 in which it is determined that the packet to be transmitted is to be transmitted by the third radio and thus assigned for scheduling to the third MAC scheduler 328. Operation then proceeds to return step 996.

If in step 990 it is determined that the UE is not entitled to receive service from the third radio, operation will proceed to step 994 in which the packet will be dropped and removed from the packet buffer 318 without transmission. Processing is shown proceeding from step 994 via connecting node D 988 to show that processing of other packets will continue even though the particular packet that was being processed is dropped.

Referring once again to the process shown in FIG. 9B, in some embodiments step 940 includes sub-step 944 which shows that the radio/service network selected for packet delivery may, and sometimes will, depend on the mode of operation of the AP. For example, when in a normal mode of operation the first radio 304 will be preferred for delivery but when in a failure mode of operation the determination in step 940 may exclude from consideration the first radio since it is in a failure state with the determination of the radio to use then being from one of the second 306 or third 308 radios. Step 940 is shown as including a step 943 assigning a first packet to be transmitted to the first service network, e.g., because the first packet is directed to the first UE 270 which is within range of the first radio. Step 940 is also shown as including step 945 which relates to the additional packet which is assigned to the third service network for delivery because it is directed to the third UE 272 which is within CBRS range but outside of the range of the first and second WiFi radios 304, 306 and the third UE 272 is entitled to a priority level which entitles the third UE 272 to CBRS packet delivery when WiFi delivery is not available.

Operation proceeds from step 940 to step 946. In step 946 the higher order MAC scheduler 320 assigns, e.g., based on the determined service network/radio to be used, the packet to one of the MAC schedules 324, 326, 328. This may involve the higher order MAC scheduler 320 indicating to the lower level MAC scheduler 324, 326 or 328, corresponding to the radio 304, 306 or 308, respectively, to be used for packet delivery, that it is responsible for scheduling and controlling the transmission of the packet via the radio corresponding to the MAC scheduler. For example, when it is determined in step 940 that a packet stored in the buffer 318 is to be delivered by the first service network via radio 304, the packet will be assigned to the 60 GHz MAC scheduler 324. In response to determining in step 940 that a packet stored in the buffer 318 is to be delivered by the second service network via radio 306, the packet will be assigned in step 946 to the 5 GHz MAC scheduler 326. Similarly in response to determining in step 940 that a packet stored in the buffer 318 is to be delivered by the third (CBRS) service network via radio 308, the packet will be assigned in step 946 to the CBRS MAC scheduler 328.

Step 946 is shown as including, in some implementations, step 948 which relates to assigning the first packet to the first MAC scheduler 304 corresponding to the first radio service network to be used to deliver the first packet. Step 946 is shown as including, in some implementations step 950 which involves assigning the additional packet to the third MAC scheduler 328 since the additional packet is to be transmitted by the third, e.g., CBRS, service network via radio 308.

With the packets having been assigned in step 946 to individual MAC schedulers corresponding to the radio to be used to transmit the individual packet, operation proceeds to step 952 in which the MAC scheduler to which the IP packet being processed was assigned schedules transmission of the packet over the corresponding radio. For example, in step 954 the first MAC scheduler 324 is operated to schedule transmission of the first IP packet for transmission via the first radio 304 since is to be transmitted over the first service network via the first radio 324. In step 956 which relates to a second IP packet the first MAC scheduler schedules it for transmission since it, like the first packet, was assigned to be transmitted over the first service network via the first radio 304. In step 958 which relates to the third/additional IP packet the third MAC scheduler 328 schedules the transmission of the third/additional packet via radio 328. It should be appreciated that step 952 is performed on a per packet basis and thus steps 954, 956 and 958 relate to processing relating to different packets and thus at different times step 952 is performed.

Operation proceeds from step 952 to step 960 in which the MAC scheduler which was assigned to handle scheduling of a transmission of a packet will control the corresponding radio to transmit the packet over the service network the packet was assigned to for transmission. For example in step 960 the first MAC scheduler will control the first radio 304 to transmit the first packet, in step 960 the first MAC scheduler will control the first radio 304 to transmit the second packet according to the determined schedule and in step 960 with regard to the third/additional packet to be transmitted over the CBRS service network, the third MAC scheduler 328 will control the CBRS radio 308 to transmit the additional/third packet.

Operation proceeds, via connecting node B 962, from step 960 in which a packet is transmitted by a radio to which is assigned, to step 964 of FIG. 9C. In step 964 the AP which transmitted the packet, e.g., the first AP 206 for purposes of explanation, monitors for an acknowledgement to the transmitted IP packet. The AP may have detected an acknowledgement to the transmitted packet which could be an ACK indicating successful receipt by the UE to which it was directed or a NAK indicating an unsuccessful receipt e.g., where a part of the packet may have been received but not the full packet. In the case where no portion of the packet is received no acknowledgement may be received since the UE did not receive anything to acknowledge.

Since an acknowledgement may or may not be received in step 964, step 966 in which an acknowledgement is received is shown in dashed lines since an acknowledgement may not be received in the case of all transmissions. The monitoring in step 964 in some cases is performed for a predetermined amount of time before operation proceeds to step 968. In step 968 a check is made to determine if an acknowledgement (positive ACK) indicating successful receipt of the transmitted IP packet was received in a predetermined time. If an acknowledgement indicating successful receipt of the transmitted packet was not received in the predetermined amount of time (e.g., as indicated by a failure to receive an acknowledgement to the packet transmission in the predetermined amount of time or by receipt of a NAK), operation proceeds from step 968 to step 972, in which a determination is made that the transmission of the packet was successful. From step 972, operation proceeds to step 974 and also proceeds to step 1794 shown in FIG. 9E via connecting node F 973.

The steps shown in FIG. 9E relate to determining if the radio which was used to transmit the packet which was not received is operating in a failure state of operation, e.g., a state in which transmission are not possible or are frequently or always unsuccessful due to a radio hardware fault, high levels of radio interference, an obstruction or for some other reason and reporting the radio failure condition to a network control device, e.g., the MANC 260 when a radio failure condition is detected. The MANC can then decide whether or not to command the AP with the failing radio to switch to a failure mode of operation and/or take steps to move UE service to another AP.

In step 1974 a packet transmission failure rate for the radio which transmitted the packet which was not received is updated. The failure rate may be, and sometimes is, expressed as a number of packet transmission failures per second. The packet failure rate updated in step 1974 is then checked in step 1976 to determine if it is over a failure rate threshold, used in determining a radio failure condition. If the packet failure rate for the transmitting radio is not over the failure rate threshold, operation proceeds from step 1976 to step 1978 in which normal AP operation continues. If in step 1976 it is determined that the radio packet failure rate is over the failure rate threshold, operation proceeds from step 1976 to step 1980 in which the AP determines that the radio which unsuccessfully transmitted the packet is suffering radio failure which is then reported in step 1982 to the network controller, e.g., MANC 260. The MANC 260 can then use the radio failure indication, e.g., received in message from the transmitting AP 206, to make a determination to switch the AP 206 from a normal mode of operation to a failure mode of operation. The AP 206 in some cases might notify the MANC 260 in step 1982 of the radio failure and then automatically switch to a failure mode of operation. The notification to the MANC may, and sometimes does, indicate the AP sending the radio failure notification as well as the particular radio suffering the failure condition. The MANC 260 can take this information into consideration when deciding whether to switch the AP 206 into a failure mode of operation. For example, failure of the second or third radios may not trigger a switch to a failure mode of operation while reporting of a failure of the higher bandwidth first radio will normally cause the MANC 260 to command the AP suffering the radio failure to switch to the failure mode of operation so that it stops trying to transmit packets using the first radio.

In the case of hardware faults or other detectable conditions causing the fault such as high levels of interference, the AP suffering a radio failure may detect when the condition which caused the failure has been corrected, e.g., the hardware has been fixed or the interference has decreased to an acceptable level. When the AP detects that the condition causing the radio failure has been eliminated or corrected it will signal to the MANC 260 that it is no longer operating with a radio suffering a failure condition and the MANC 260 will normally respond by sending the AP a message e.g., command which controls or otherwise causes the AP in the failure mode of operation but with the corrected radio condition to resume normal operation and return to a normal mode of operation. The MANC 260 stores the mode of operation for APs in a memory device and uses the stored AP mode information when making various network decisions.

Referring once again to FIG. 9C, step 974 represents the start of processing relating to retransmission of the packet. The retransmission can be via the same radio used to initially transmit the packet or via a different radio. In some embodiments the retransmission of a packet is transmitted multiple times by the radio to which it is initially assigned before retransmission by another radio, assuming one is available at the AP is implemented. In the example shown in FIG. 9 for simplicity retransmission is shown being implemented using a different radio upon a single transmission failure by the radio initially assigned to transmit the packet.

In step 974 the higher order MAC scheduler 320 selects a different service network and radio than the one that was used in the unsuccessful packet transmission for retransmission of the packet which remains in the IP packet buffer. In the case where the first service network/first radio was used in the unsuccessful packet transmission, the second or third radios will be selected for the retransmission with, in most cases the second service network/radio being tried before moving on to using the third service network and corresponding radio. Step 974 includes in some cases step 976 of selecting the second service network and second radio 306 for use in retransmitting the packet while in other cases step 974 includes step 978 of selecting the third service network and third radio 308 for retransmitting the packet.

Operation proceeds from step 974 to step 980, in which the packet to be retransmitted is assigned by the higher order MAC scheduler 320 to the MAC scheduler 326 or 328 corresponding to the service network and radio to be used for packet retransmission. Then in step 982 the MAC scheduler to which the packet is assigned for re-transmission schedules the retransmission, and in step 984 the MAC scheduler to which the packet is assigned for re-transmission controls the corresponding radio to transmit the IP packet to be retransmitted. For example, when a second packet original transmitted by the first radio 30 is not successful received it may be assigned for retransmission to the second service network, scheduled for retransmission by the second MAC scheduler 326 and then transmitted by the second radio 306 in accordance with the schedule determined by the second MAC scheduler 326.

With the retransmission of the packet, operation proceeds via connecting node C 986 from step 984, in which the packet is transmitted, back to monitoring step 964, where the AP (e.g., transmitting radio of the AP) monitors for receipt of an acknowledgement to the transmitted packet which in the case of progression from step 984 will be a retransmitted packet. A packet may be retransmitted multiple times using one or more radios before being discarded as undeliverable in the event that a positive acknowledgement is not received during a maximum storage time associated with the packet encountering the communication problem. The maximum storage time may be a predetermined amount of time set to prevent the excessive storage of packets for UEs that may have left the coverage area of the AP where the packet is stored.

Having discussed the case where a transmitted packet is not successfully acknowledged indicating lack of receipt by the UE to which it was directed, the case where a transmitted packet is successfully received and acknowledged will now be discussed. Referring once again to step 968 of FIG. 9C, if it is determined that an acknowledgement indicating successful receipt of the transmitted packet was received by the UE to which it was sent, operation proceeds from step 968 to step 970 in which the successfully communicated packet is removed, e.g., deleted, from the IP packet buffer 318. Operation is shown proceeding from step 970 to step 940 via connecting node D 988 to show that packet processing is performed on an ongoing basis so that the packets stored in the buffer will continue to be transmitted based on their assignment to radios until the packet is deleted from the buffer due to successful transmission or for some other reason such as expiration of a maximum buffer storage timer associated with an individual packet.

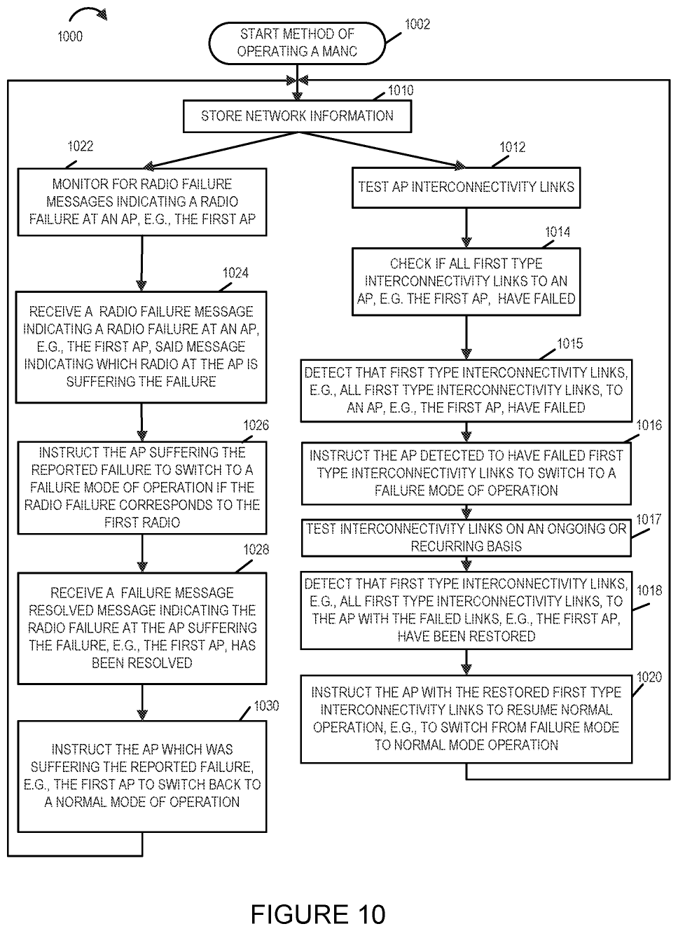

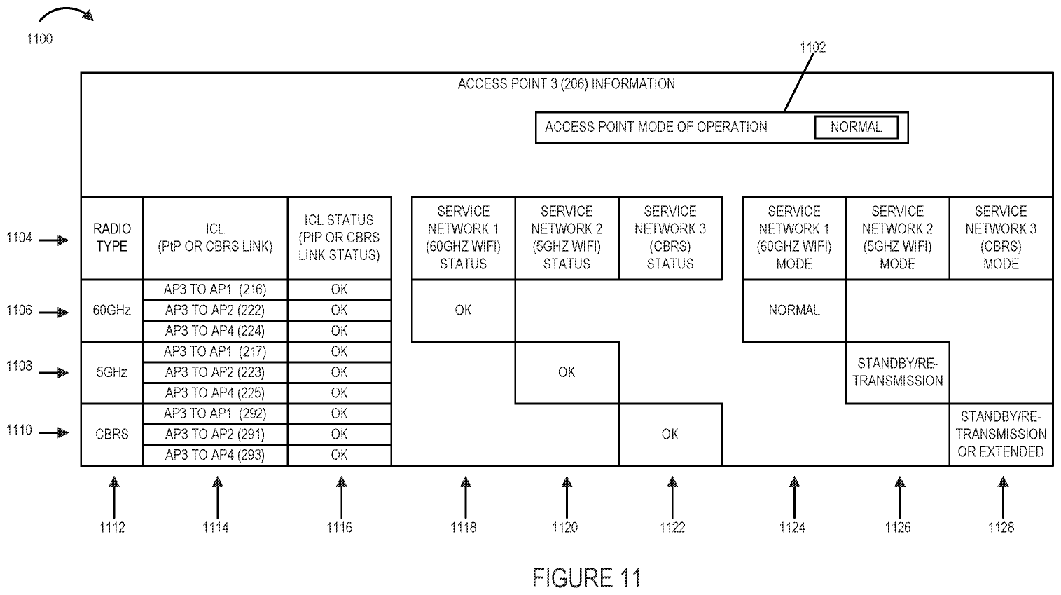

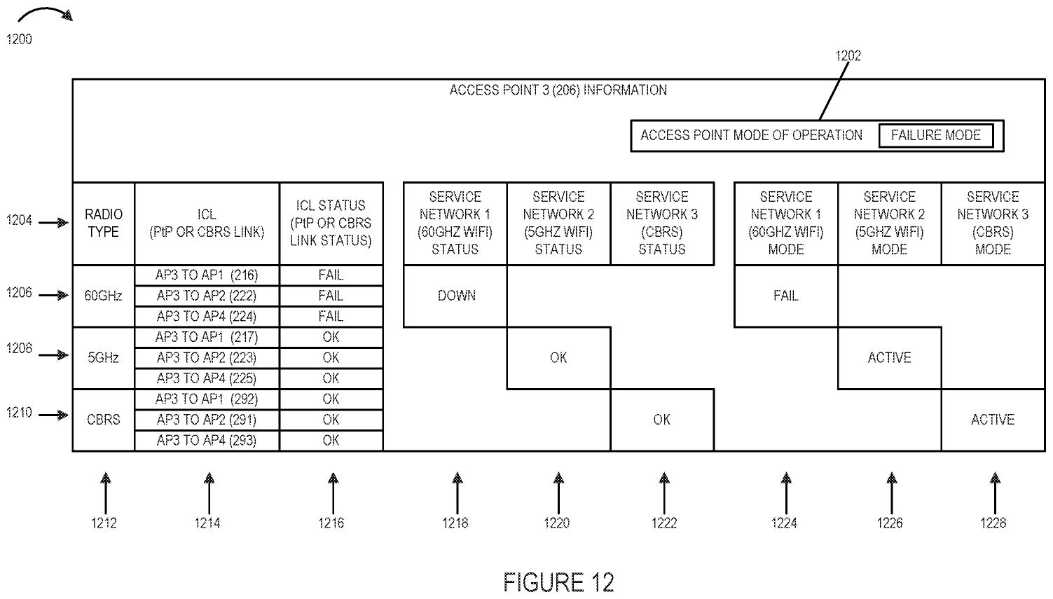

FIG. 10 which shows the steps 1000 of a method of operating a multi-access network controller (MANC) 260 in accordance with one exemplary embodiment. The method beings in start step 1002 with the MANC being powered on. Then in step 1010 the MANC stores network information such as the exemplary information shown in FIGS. 11 and 12. The MANC automatically updates the stored network information as it becomes aware of changes to the stored information resulting in the stored information changing over time as the network changes and the MANC becomes aware of such changes via received failure notifications, results of link testing or by the fact that the MANC controlled an AP to switch between modes of operation, e.g., to switch from a normal mode of operation to a failure mode of operation.

From step 1010 operation proceeds along two parallel paths with one path beginning with link testing step 1012 and the other path beginning with message monitoring step 1022 in which the MANC monitors for messages including failure messages indicating failure at an AP, e.g., the first AP or any other AP of a radio. For purposes of explaining the invention it will be assumed that failure messages and failed links relate to the first AP, but this is for purposes of explanation and the messages/link failure detections could relate to any of the multiple APs in the communication system 200.

In step 1012 the MANC tests the AP interconnectivity links, e.g., by sending ping messages over them and checking for responses. Operation proceeds from step 1012 to step 1014, in which a check is made to determine if all first type interconnectivity links to an individual AP, e.g., the first AP, have failed which would be indicative of failure of the first radio at the AP.

In step 1015 it is detected, based on the check made in step 1014, that the first type interconnective links, e.g., all the first type interconnectivity links, to an AP, e.g., the first AP have failed. In response to the detection of the failure, the MANC instructs the AP suffering the radio failure, in step 1016, to switch to a failure mode of operation, e.g., by sending a command in a message to the AP suffering the failure.

The MANC tests the interconnectivity links on a recurring or ongoing basis in step 1017. In step 1018 the MANC detects that the first type interconnectivity links to the AP suffering the first type radio failure, e.g., the first AP, have been restored indicating the first radio at the AP is now functioning properly. In response to the detection of the restoration of the first type links at the AP which suffered the failure, e.g., the first AP, the MANC, in step 1020, instructs the AP to switch back from the failure mode of operation to the normal mode of AP operation. During the failure mode of operation triggered by the first radio, the first AP will cease scheduling transmissions from the first radio and switch to scheduling downlink transmission from the second and/or third radios at the first AP.

Operation is seen proceeding from step 1020 back to testing step 1012 to show that the testing and steps relating to testing results are performed on an ongoing basis.

Referring now to step 1022 which is performed in parallel with testing step 1012, the MANC monitors for radio failure messages that indicating a radio failure at an AP. Such messages normally indicate the AP reporting the radio failure and which radio at the AP is subject to the failure condition. As discussed elsewhere the reported failure can be due to a hardware failure but can also be due to interference or a physical obstruction which makes successful transmission from the first radio difficult or impossible.

In step 1024 a radio failure message is received at the MANC indicating a radio failure at an AP, e.g., the first AP for purposes of this example. The radio failure message indicates the AP suffering the failure and which of the AP's radios are suffering the failure. The MANC decides whether or not to switch the AP reporting the failure into a failure mode of operation. The MANC will normally switch the AP into the failure mode of operation when the first radio fails since this is the primary and highest bandwidth radio used by the AP. In step 10126 the MANC instructs the radio suffering the reported failure to switch to failure mode of operation, e.g., because the reported failure indicates failure of the first radio at the AP, e.g., first AP.

The AP will check if the failure condition it reported is resolved and will send a failure resolved message to the MANC when it detects that a previously reported radio failure has been resolved and that the radio is now working properly.

In step 1028 the MANC receives a radio failure resolved message indicating that the previously reported radio failure, e.g., the failure at the first AP of its first radio, has been resolved and the first radio is useable once again. Operation proceeds from step 1028 to step 1030 in which the MANC instructs the AP, operating in the failure mode of operation, to switch from the failure mode of operation back to a normal mode of operation in which the first radio will, once again, be used to transmit packets. Operation is shown going from step 1030 to monitoring step 1022 to indicate that monitoring for messages from APs is performed on an ongoing basis and the MANC will act on messages, both radio failure messages and radio failure resolution messages, as they are received. The MANC will update the stored network information as APs are controlled to switch between normal and failure modes of operation so that the stored information accurately reflects the current mode of operation and state of the AP links and/or radios.

FIG. 11 illustrates network information which is stored for a period of time in which access point 3 (AP3 206) is operating in a normal mode of operation while FIG. 12 illustrates stored network information corresponding to a period of time in which the third access point (AP3 206) is operating in a failure mode of operation. Similar information is stored for each of the APs in the system of FIG. 2 in which the MANC 260 is located.

FIG. 11 is a drawing 1100 of exemplary information for access point 3(AP3) 206 which may be stored in a MANC, e.g., MANC 260, when the mode of operation for AP 3 206 is normal mode, in accordance with an exemplary embodiment. Block 1102 indicates that the access point mode of operation is normal. Row 1104 includes titles which identify the type of information included in each column (1112, 1114, 1116, 1118, 1120, 1124, 1126, 1128). Radio type information is included in column 1112. Interconnectivity link (ICL) identification information is included in column 1114. The ICL, which goes between two APs, may be a PtP link or a CBRS link. ICL status information is included in column 1116. Service network 1, which is 60 GHz WiFi network, status information is included in column 1118. Service network 2, which is 5 GHz WiFi network, status information is included in column 1120. Service network 3, which is CBRS network, status information is included in column 1122. Service network 1, which is 60 GHz WiFi network, mode information is included in column 1124. Service network 2, which is 5 GHz WiFi network, mode information is included in column 1126. Service network 3, which is CBRS network, mode information is included in column 1128.

In this example, there are three ICL links for each radio type and the ICL status for each ICL link is OK. The status of 60 GHz PtP ICL 216, which goes between AP3 to AP1 is ok; the status of 60 GHz PtP ICL 222, which goes between AP3 to AP2 is ok; and the status of 60 GHz PtP ICL 224, which goes between AP3 and AP4 is ok. The status of 5 GHz PtP ICL 217, which goes between AP3 to AP1 is ok; the status of 5 GHz PtP ICL 223, which goes between AP3 to AP2 is ok; and the status of 5 GHz PtP ICL 225, which goes between AP3 and AP4 is ok. The status of CBRS ICL 292, which goes between AP3 to AP1 is ok; the status of CBRS ICL 291, which goes between AP3 to AP2 is ok; and the status of CBRS ICL 293, which goes between AP3 and AP4 is ok.

The status of service network 1 is ok, as indicated in column 1118; the status of service network 2 is ok, as indicated in column 1120; and the status of service network 3 is ok, as indicated in column 1122. Service network 1 is in normal mode of operation, as indicated in column 1124; service network 2 is in standby/re-transmission mode of operation, as indicated in column 1126; and service network 3 is in standby/re-transmission mode of operation or extended mode of operation, as indicated in column 1128.

FIG. 12 is a drawing 1200 of exemplary information for access point 3(AP3) 206 which may be stored in a MANC, e.g., MANC 260, when the mode of operation for AP 3 206 is failure mode, in accordance with an exemplary embodiment. Block 1202 indicates that the access point mode of operation is failure mode. Row 1204 includes titles which identify the type of information included in each column (1212, 1214, 1216, 1218, 1220, 1224, 1226, 1228). Radio type information is included in column 1212. Interconnectivity link (ICL) identification information is included in column 1214. The ICL, which goes between two APs, may be a PtP link or a CBRS link. ICL status information is included in column 1216. Service network 1, which is 60 GHz WiFi network, status information is included in column 1218. Service network 2, which is 5 GHz WiFi network, status information is included in column 1220. Service network 3, which is CBRS network, status information is included in column 1222. Service network 1, which is 60 GHz WiFi network, mode information is included in column 1224. Service network 2, which is 5 GHz WiFi network, mode information is included in column 1226. Service network 3, which is CBRS network, mode information is included in column 1228.

In this example, there are three ICL links for each radio type. The status for each of the ICLs (AP3 to AP1 link 216, AP3 to AP2 link 222, AP3 to AP4 link 224) corresponding to the 60 GHz radio, which are PtP 60 GHz links is FAIL. The status for each of the ICLs (217, 223, 225) corresponding to the 5 GHz radio is OK. The status for each of the ICLs (292, 291, 293) corresponding to the CBRS radio is OK. The status of service network 1 is down, as indicated in column 1218; the status of service network 2 is ok, as indicated in column 1220; and the status of service network 3 is ok, as indicated in column 1222. Service network 1 is in fail mode of operation, as indicated in column 1224; service network 2 is in active mode of operation, as indicated in column 1226; and service network 3 is in active mode of operation, as indicated in column 1228.

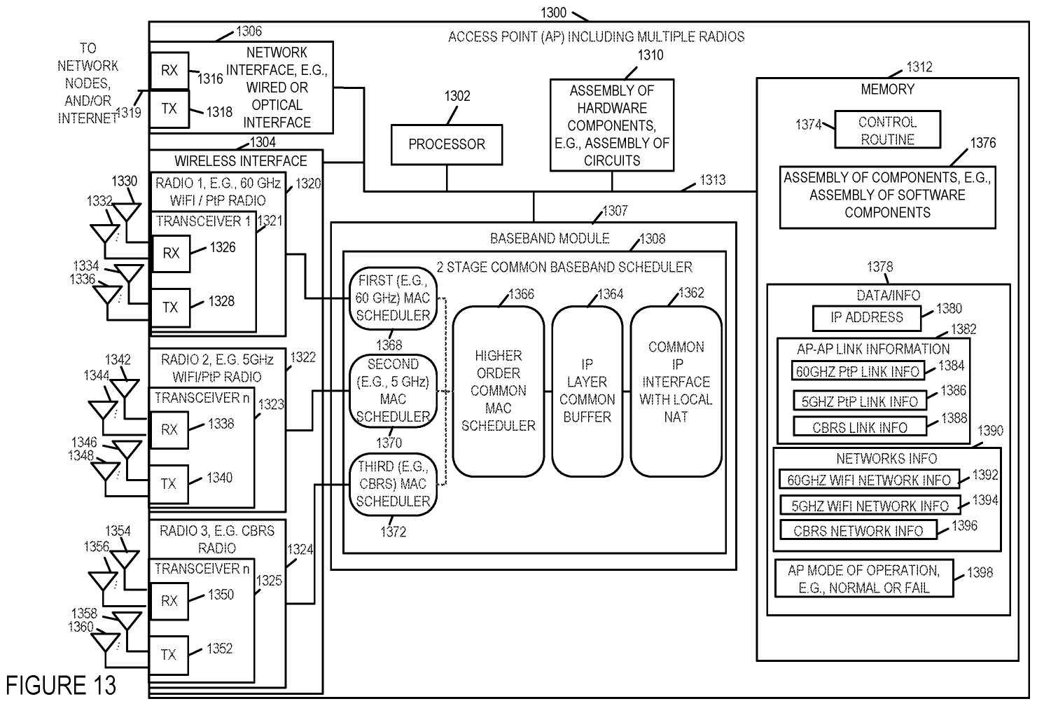

FIG. 13 is a drawing of an exemplary access point (AP) 1300 including multiple radios in accordance with an exemplary embodiment. AP 1300 is, e.g., any of the APs 202, 204, 208, 208, 210 of system 200 of FIG. 2. Exemplary AP 1300 includes a processor 1302, e.g., a CPU, a wireless interface 1304, a network interface 1306, a baseband module 1307, an assembly of hardware components 1310, e.g., an assembly of circuits, and memory 1312 coupled together via a bus 1313 over which the various elements may interchange data and information.

Wireless interface 1304 includes a plurality of radios including radio 1 1320, radio 2 1322 and radio 3 1324. Radio 1 1320, e.g., a 60 GHz WiFi radio which also supports PtP signaling, includes transceiver 1321 which includes receiver 1326 and transmitter 1328. Receiver 1326 is coupled to a plurality of receive antennas or receive antenna elements (1330, . . . , 1332) via which AP 1300 receives 60 GHz WiFi signals from UEs and 60 GHz PtP signals from other APs. Transmitter 1328 is coupled to a plurality of transmit antennas or transmit antenna elements (1334, . . . , 1336) via which AP 1300 transmits 60 GHz WiFi signals to UEs and 60 GHz PtP signals to other APs. In some embodiments, one or more of the same antennas or antenna elements are used for both reception and transmission.

Radio 2 1322, e.g., a 5 GHz WiFi radio which also supports PtP signaling, includes transceiver 1323 which includes receiver 1338 and transmitter 1340. Receiver 1338 is coupled to a plurality of receive antennas or receive antenna elements (1342, . . . , 1344) via which AP 1300 receives 5 GHz WiFi signals from UEs and 5 GHz PtP signals from other APs. Transmitter 1340 is coupled to a plurality of transmit antennas or transmit antenna elements (1346, . . . , 1348) via which AP 1300 transmits 5 GHz WiFi signals to UEs and 5 GHz PtP signals to other APs. In some embodiments, one or more of the same antennas or antenna elements are used for both reception and transmission.

Radio 3 1324, e.g., a CBRS radio includes transceiver 1325 which includes receiver 1350 and transmitter 1352. Receiver 1350 is coupled to a plurality of receive antennas or receive antenna elements (1354, . . . , 1356) via which AP 1300 receives CBRS signals from UEs and CBRS signals from other APs. Transmitter 1352 is coupled to a plurality of transmit antennas or transmit antenna elements (1358, . . . , 1360) via which AP 1300 transmits CBRS signals to UEs and CBRS signals to other APs. In some embodiments, one or more of the same antennas or antenna elements are used for both reception and transmission.

Network interface 1306, e.g., a wired or optical interface, includes receiver 1316, transmitter 1318 and connector 1319, via which the AP 1300 can be coupled to the Internet, e.g., by a wireline or fiber connection, e.g., when the AP 1300 is serving as a network anchor.

Baseband module 1307 includes a 2-stage common baseband scheduler 1308. The 2-stage common baseband scheduler includes a common IP interface with local NAT 1362, an IP layer common buffer 1364, a higher order common MAC scheduler 1366 and a plurality of MAC schedulers corresponding to different access network radio types (1st, e.g., 60 GHz, MAC scheduler 1368, 2nd, e.g., 5 GHz, MAC scheduler 1370, 3rd, e.g., CBRS, MAC scheduler).

In an exemplary embodiment in which AP 1300 is AP3 206, radio 1 1320 is 60 GHz radio 304, radio 2 1322 is 5 GHz radio 306, radio 3 1324 is CBRS radio 308, baseband module 1307 is common baseband module 302, 2-stage common baseband scheduler 1308 is 2-stage common baseband scheduler 310, common IP interface with NAT 1362 is common IP interface with NAT 316, IP layer common buffer 1364 is IP layer common buffer 318, higher order common MAC scheduler 1366 is higher order common MAC scheduler 320, 1st MAC scheduler (e.g., a 60 GHz MAC scheduler) 1368 is 60 GHz MAC scheduler 324, 2nd MAC scheduler (e.g., a 5 GHz MAC scheduler) 1370 is 5 GHz MAC scheduler 326, 3rd MAC scheduler (e.g., a CBRS MAC scheduler) 1372 is CBRS MAC scheduler 328.

In an exemplary embodiment in which AP 1300 is AP1 202, radio 1 1320 is 60 GHz radio 404, radio 2 1322 is 5 GHz radio 406, radio 3 1324 is CBRS radio 408, baseband module 1307 is common baseband module 402, 2-stage common baseband scheduler 1308 is 2-stage common baseband scheduler 410, common IP interface with NAT 1362 is common IP interface with NAT 416, IP layer common buffer 1364 is IP layer common buffer 418, higher order common MAC scheduler 1366 is higher order common MAC scheduler 420, 1st MAC scheduler (e.g., a 60 GHz MAC scheduler) 1368 is 60 GHz MAC scheduler 424, 2nd MAC scheduler (e.g., a 5 GHz MAC scheduler) 1370 is 5 GHz MAC scheduler 426, 3rd MAC scheduler (e.g., a CBRS MAC scheduler) 1372 is CBRS MAC scheduler 428.

Memory 1312 includes a control routine 1374, an assembly of components 1376, e.g., assembly of software components, and data/information 1378. Control routine 1374 includes machine executable instructions, which when executed by processor 1302 control the AP 1300 to perform basic operations including, e.g., read from memory, write to memory, operate an interface, etc. Assembly of software components 1376 includes machine executable instructions, which when executed by processor 1302 control the AP 1300 to perform steps of an exemplary method in accordance with the present invention, e.g., step of the method of flowchart 900 of FIG. 9. Data/information 1378 includes an IP address 1380 corresponding to AP 1300, AP-AP link information 1382 including 60 GHz PtP link information 1384, 5 GHz PtP link information 1386, and CBRS link information 1388. Data/information 1378 further includes networks information 1390 including 60 GHz WiFi network information 1392, 5 GHz WiFi network information 1394 and CBRS network information 1396. Data/information 1378 further includes the current AP mode of operation of AP 1300, which is one of normal mode of failure mode.

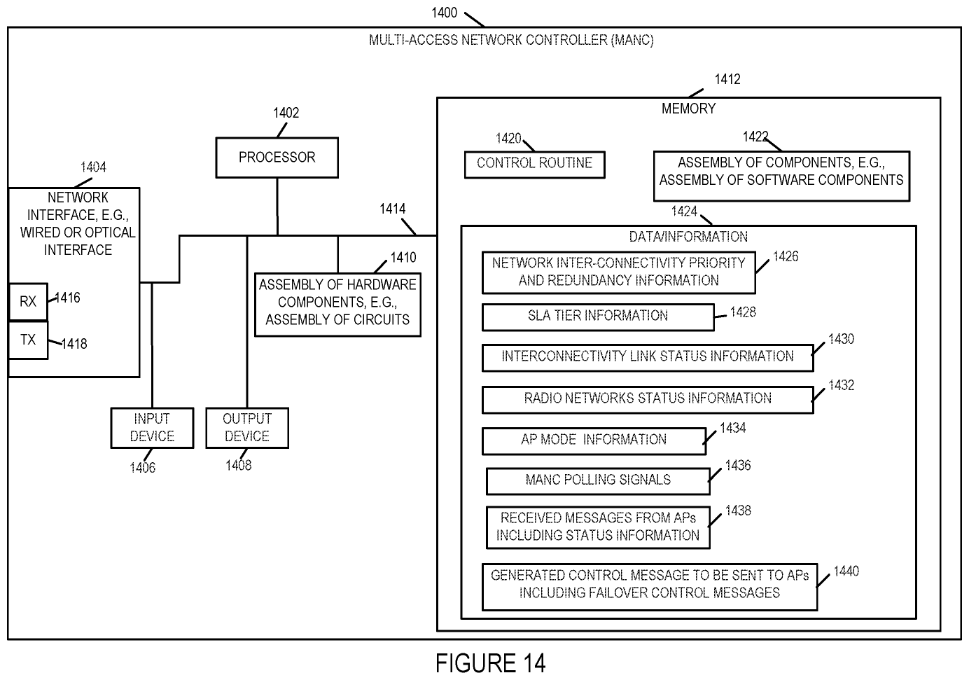

FIG. 14 is a drawing of an exemplary Multi-Access Network Controller (MANC) 1400 in accordance with an exemplary embodiment. MANC 1400 is, e.g., MANC 260 of system 200 of FIG. 2.

MANC 1400 includes a processor 1402, e.g., a CPU, a network interface 1404, e.g., a wired or optical interface, an input device 1406, e.g., a keyboard or mouse, an output device 1408, e.g., a display, an assembly of hardware components 1410, e.g., an assembly of circuits, and memory 1412 coupled together via a bus 1414 over which the various elements may interchange data and information. Network interface 1404 includes a receiver 1416 and a transmitter 1418. Network interface 1400 couples the MANC 1400 to APs including multiple radios, and a SAS, e.g., via the Internet and/or other links including, e.g., wireless PtP links between APs. MANC 1400 receives status information regarding access networks corresponding to APs and status information regarding links between APs via receiver 1416. MANC 1400 sends control messages to APs via TX 1418 to manage the APs, e.g., sending decisions to the APs as to which access network to switch to in response to a detected network failure or link(s) failure, and/or the mode of operation to put an AP into at a particular time, e.g., based on detected failure information, access network priority information, SLA information, and a failover management plan.

Memory 1412 includes a control routine 1420, an assembly of components 1422, e.g., assembly of software components, and data/information 1424. Control routine 1420 includes machine executable instructions, which when executed by processor 1402 control the MANC 1400 to perform basic operations including read to memory, write to memory, operate an interface, etc. Assembly of software components 1422 includes machine executable instructions, which when executed by processor 1402 control the MANC 1400 to perform steps of an exemplary method in accordance with the present invention, e.g., step of the method of flowchart 1000 of FIG. 10. Data/information 1424 includes network inter-connectivity priority and redundancy information 1426, SLA tier information 1428, interconnectivity link status information 1430, radio networks status information 1432, AP mode information 1434, MANC polling information 1436, received messages from APs including status information 1438 and generated control messages 1440 to be sent to APs including failover control messages.

Various aspects and/or features of some embodiments of the present invention are further discussed below. In various embodiments, an exemplary implementation includes multi-band multi-access radios. An exemplary communications network, in some embodiments, is structured and implemented using a full complement of multi-access, multi frequency networks ensuring complete intra-network and extended network coverage.

An exemplary communications system, in accordance with the present invention, includes a plurality of access points (APs) including at least one network anchor and a Multi-Access Network Controller (MANC). The AP, which is a network anchor, is coupled to the MANC, e.g., via the Internet. In some embodiments, e.g., in which at least some of the APs support CBRS communications, the communications system further includes a SAS. An exemplary access point includes multiple radios (e.g., a 5 GHz radio, a 60 GHz radio, and a CBRS radio) and a common baseband. Physical connectivity of radios with baseband is implemented, in some embodiments, through single mode (SM) fiber jumpers. The APs service UEs via WiFi communications (e.g., 60 GHz WiFi and 5 GHz WiFi) and via CBRS (3GPP) communications. The APs are coupled to one another via PtP/PtMP links and/or CBRS links (e.g., 60 GHz PtP/PtMP (IEEE) links, 5 GHz PtP/PtMP (IEEE/proprietary) links and/or CBRS links.

Inter-radio communications are implemented through the common baseband. Baseband maintains common MAC and RLC layer functions for the independent radios through a local buffer and processor that switches the UDP path based on the defined access mechanism priorities by the MANC.

Once MANC notifies the path switch based on keep alive mechanism reporting, the common basebands at each radio location implement the access network switching by directing the PDU session to the alternative access mechanism.

In various embodiments, an access point includes a common baseband which includes a 2-stage common baseband scheduler. The common baseband in the AP is coupled to the multiple radios (e.g., a 5 GHz radio, a 60 GHz radio, and a CBRS radio) in the AP. Stage 1 of the 2-stage common baseband scheduler includes: a common IP interface with local NAT, an IP layer common buffer, and a higher order common MAC scheduler. The common IP interface, to egress and ingress traffic, maintains a singular IP address. The approach of a common IP interface with a singular IP address eliminates the need for IP reconfiguration during access mechanism switching. The IP common buffer includes an IP packet flow. Stage 2 of the 2-stage common baseband scheduler includes access technology specific MAC schedulers (e.g., a 60 GHz MAC scheduler, a 5 GHz MAC scheduler, and a CBRS MAC scheduler), and access switching technology.

Exemplary 2-stage scheduler operation during failover will now be described, e.g., with respect to one 2-stage scheduler in an AP. Consider that the IP layer common buffer includes local buffer copies of packets (e.g., packet 1, packet 2, packet 3, packet 4). Consider that the higher order common MAC scheduler has scheduled the packets for the 60 GHz MAC scheduler which is coupled to the 60 GHz radio in the AP. Consider that the 60 GHz radio starts transmitting packets 1 and 2; however, the transmission is not successful, e.g., the intended recipient device does not successfully recover the packets. A link failure is detected, e.g., by the AP. The AP, e.g., the 2 stage scheduler in the AP, communicates with the MANC and a decision is made on which access type to switch to (e.g., switch from 60 GHz to 5 GHz or switch from 60 GHz to CBRS). The 2-stage scheduler performs access type switching in accordance with the decision.

The higher order common MAC scheduler now directs the packets (e.g., copies of packet from the IP layer common buffer) toward the newly selected access type MAC scheduler, e.g., the higher order MAC scheduler now directs the packets toward the 5 GHz MAC scheduler or, which is coupled to the 5 GHz radio, or toward the CBRS MAC scheduler, which is coupled to the CBRS radio. The AP is operated to subsequently retransmit copies of the lost transmission over the newly selected access network, e.g., the 5 GHz WiFi network or the CBRS network, said copies of the lost transmissions having been sourced from the IP layer common buffer.

Exemplary network selection decision flow by MANC will now be described. Network interconnectivity priorities and redundancy order are defined. For example, in one exemplary embodiment, 60 GHz interconnectivity links (e.g., 60 GHz PtP/PtMP) links between APs are defined to have priority 1, 5 GHz interconnectivity links (e.g., 5 GHz PtP/PtMP) links between APs are defined to have priority 2, and CBRS links between APs are defined to have priority 3. In various embodiments, the service criteria (e.g., for UEs being serviced by the APs) is maintained (if possible) when failover occurs, with notifications from the MANC to the APs being used to control access switching. In one example, the various SLA tiers are: SLA tier 1: 500 Mbps×500 Mbps (60 GHz); SLA tier 2: 200 Mbps×200 Mbps (5 GHz); and SLA tier 3: 50 Mbps×10 Mbps (CBRS).

The MANC receives an access type 1 failure notification, e.g., a notification indicating that there is a 60 GHz failure with regard to a particular AP, e.g., due to 60 GHz radio failure at the AP, or due to obstructions or interference resulting in one or more 60 GHz PtP link with the AP be unusable. The MANC determines which alternative access services are available. The MANC uses pre-defined network interconnectivity priority information, pre-defined service level agreement (SLA) information, information indication the area affected by the failure, and a service area look-up table, to determine which of the available alternative access services to switch (e.g., 5 GHz and/or CBRS) to in response to the detected failure. The MANC generates and sends a notice to the affected AP(s) including radio(s) to perform access switching. The AP implements the access switching in accordance with the control messages from the MANC, thus completing the failover.

Intra-network operation enablement through the MANC will now be described. In various embodiments, the benefits of non-line of sight (non-LOS) propagation of lower spectrum bands anchored through a MANC are leveraged. For example, when 60 GHz PtP links are obstructed between APs, 5 GHz links may be, and sometimes are used, under the control of the MANC, to support connectivity between APs. Similarly, when 60 GHz PtP links and 5 GHz PtP links are obstructed between APs, CBRS links may be, and sometimes are, used under the control of the MANC, to support connectivity between APs.

Exemplary Multi-Access Network Controller (MANC) operation will now be described. The MANC establishes the interconnectivity through PtP/PtMP links for each solution. The MANC acts as a proxy between deployed network and SAS for CBRS and service activation/operation. The MANC defines the service area for each access mechanism regardless of the technology (3GPP vs IEEE vs proprietary) through manually measured and defined service footprint or through subscriber reported messages (e.g., defined based on signals strength and/or user speed). In some embodiments, criteria can be, and sometimes is, configurable. The MANC, in some embodiments, defines the extended service tier (when serving outside the core region (e.g., corresponding to WiFi network(s)) via CBRS) and deliverable service. The MANC acts as the primary service speed controller and controls failover when an access mechanism (or a link) is disrupted. The MANC enables graceful recovery of each service layer for full restoration when service is interrupted and places the redundancy layers on stand-by when service through the primary links is restored. The MANC anchors the primary public IP address to each of the served subscribers and preforms NAT operation for ingress/egress traffic.

MANC operation through network prioritization will now be described. In some embodiments, the MANC defines network inter-connectivity priorities and redundancy order, e.g., interconnectivity link priority 1: 60 GHz, interconnectivity link priority 2: 5 GHz, and interconnectivity link priority 3: CBRS. In some embodiments, the MANC maintains the service criteria and performs notification(s) when failover occurs. Exemplary service criteria, which is maintained, is: SLA tier 1: 500 Mbps×500 Mbps (60 GHz); SLA tier 2: 200 Mbps×200 Mbps (5 GHz); and SLA tier 3: 50 Mbps×10 Mbps (CBRS).

Graceful failover and recovery through MANC will now be described. Network and service assurance, defined (e.g., by MANC) by assigning priorities for each network type, is mapped (e.g., by MANC) to SLAs. For example, interconnectivity link priority 1: 60 GHz-SLA tier 1; interconnectivity link priority 2: 5 GHz-SLA tier 2; and interconnectivity link priority 3: CBRS-SLA tier 3.

Service up-time is measured through keep-alive timers (timer t1, timer t2, . . . , timer tn), with a keep alive timer implemented on each link by access type, is used to determine the status of each link by access type, at a configurable periodicity Pn for the respective networks, with pre-configurable responsiveness criteria Cn. In some embodiments, polling is performed by MANC to each physical radio and logical link-including the verification of SAS and end to end internet connectivity.

If priority 1 network (e.g., 60 GHz network) is established and end subscriber network traffic is measured on the configured VLAN, then: i) the MAC notifies the other two networks (Priority 2 network (e.g., 5 GHz network) and Priority 3 network (e.g., CBRS network)) to transition to an active-stand-by state or ii) the MAC activates two service networks where both Priority 1 tier operates within the service footprint of its network (at SLA tier 1), and an extended subset of subscribers are served by the Priority 3 network under SLA tier 3.

If the MANC determines that the priority 1 network has failed, e.g., at a AP, in some embodiments, the MANC commands the AP to switch to failure mode of operation in which the AP uses the Priority 2 network (e.g., 5 GHz network) and/or the Priority 3 network (e.g., CBRS network).

Once service for the priority 1 network is restored, e.g., detected by the MANC, through keep alive timer responsiveness, the MANC re-enables the Priority 1 network and underlying radio activation while ensuring service continuity using the same IP address assignment.

### NUMBERED LIST OF EXEMPLARY METHOD EMBODIMENTS

Method Embodiment 1. A communications method, the method comprising: receiving (922), at a first access point (AP) (206) including an interface (316) having a first IP address corresponding to the first AP (206) during a normal mode of AP operation, IP packets (322) that are directed to said first IP address and which are to be transmitted to one or more UEs (270, 271, 272) which are receiving service from the first AP (206); storing (930) the received IP packets (322) in an IP packet buffer (318) used to supply packets to a plurality of different radios (304, 306, 308) included in said first AP (206); operating (946) a higher order common MAC scheduler (320) at the first AP to determine which of a plurality of radio network MAC schedulers (324, 326, 328) is to schedule transmission of individual IP packets stored in the IP packet buffer (318) (e.g., with said determination as to which radio network MAC scheduler (324, 326, 328) is to schedule the transmission of an IP packet also being a determination as to which radio (304, 306, or 308) is to transmit the packet since the determined scheduler corresponds to a particular radio (304, 306 or 308) and radio network at the first AP 206), said plurality of radio network MAC schedulers (324, 326, 328) including a first MAC scheduler (324) corresponding to a first radio (304), said first radio being one of said plurality of different radios (304, 306, 308); and operating (960) the first MAC scheduler (324) to control a first radio (304) at the first AP (206) to transmit packets to a first UE (270) over a first radio network (e.g., 60 GHz radio network).
Method Embodiment 2. The communications method of Method Embodiment 1, further comprising: operating the first access point (206) to receive (966) an acknowledgment from the first UE (270) indicating that the first packet was successfully received by the first UE (e.g., radio (304) receives an ACK from the first UE with regard to the first packet); and operating the first access point to remove (970) a first transmitted packet from the IP packet buffer (318) in response to a receiving an acknowledgement from the first UE (270) to which the first packet was transmitted indicating successful receipt of the first packet by the first UE (e.g., in response to the first radio (304) receiving an ack to the first packet that was transmitted to the first UE (270) the first AP (206) deletes the successfully communicated first packet from the IP packet buffer 318)).
Method Embodiment 3. The communications method of Method Embodiment 2, further comprising: operating the first access point (206) to determine (972) that transmission of a second packet to the first UE (270) from the first radio (304) was unsuccessful (e.g., an acknowledgement was not received from the first UE (270) in response to transmission of the first packet from the first radio (304) within a predetermined time or a NAK was received from the first UE (270) with regard to the second packet); and operating the higher order common MAC scheduler (220) at the first AP (206) to assign (980) the second packet to a second MAC scheduler (326) to schedule retransmission of the second packet stored in said IP packet buffer (318) to the first UE (270) over a second communications network, said second communications network being different from said first communications network (e.g., the 5 GHz network or the CBRS network if the 5 GHz network is unavailable); and operating the second MAC scheduler (326) to control (984) a second radio (306) at the first AP (206) to transmit the second packet to the first UE (270) over the second radio network (e.g., 5 GHz radio network).
Method Embodiment 4. The method of Method Embodiment 1, further comprising: receiving (928), at the first AP (206) an additional IP packet directed to said first IP address, said additional IP packet being a packet which is to be transmitted to an additional UE (e.g., UE3 272) receiving service at said first AP (206) but which is outside the range of said first radio (304) and said second radio (306); storing (936) the additional IP packet in the IP packet buffer (318) used to supply packets to a plurality of different radios (304, 306, 308); and operating the higher order common MAC scheduler (320) to assign (950) the additional packet to a third MAC scheduler (326) which is used to control a third radio (308) at the first AP (206).
Method Embodiment 5. The method of Method Embodiment 4, further comprising: operating the third MAC scheduler (328) to control (960) the third radio (308) to transmit the additional packet over a third wireless network packet link to the additional UE (372).
Method Embodiment 6. The method of Method Embodiment 5, further comprising: checking (990), prior to assigning the additional packet to the third MAC scheduler (328) (e.g., at a higher order common MAC scheduler (320) of the first AP (206)), that said additional packet is directed to a UE entitled to receive CBRS service and that said additional UE (272) to which the additional packet is directed is out of range of the first and second radios (304, 306); and wherein the higher order common MAC scheduler (320) is operated to assign (992) the additional packet to the third MAC scheduler (328) in response to determining that the additional UE (272) to which the additional packet is directed is entitled to receive CBRS service and that the additional UE (272) is out of range of the first and second radios (304, 306).
Method Embodiment 7. The method of Method Embodiment 1, further comprising: operating a Multi-Access Network Controller (MANC) to perform one or both of: i) detecting failure of one or more interconnectivity links between access points (APs) (e.g., by detecting a ping response over a interconnectivity link); and ii) receiving a failure message from an AP indicating failure of a radio at the AP or indicating failure of a service network at the AP from which the message is received.
Method Embodiment 7A. The method of Method Embodiment 7 further comprising: storing (1010) network information (e.g., in a storage device which is part of the MANC or accessible to the MANC), said network information (e.g., network information table) including access point (AP) interconnectivity link information (e.g., information indicating AP interconnectivity information; and operating the MANC to test (1012) AP interconnectivity links (e.g., send a ping message over the link and check for a response) to detect failure of AP interconnectivity links.
Method Embodiment 8. The method of Method Embodiment 7A, further comprising: operating the MANC, in response to the MANC detecting that all interconnectivity links of the first type to the first AP have failed, to instruct (1016) the first AP to switch from a normal mode of operation to a failure mode of operation in which received packets are assigned for transmission to the second and third service networks at the first AP without first being assigned to the first service network for transmission.
Method Embodiment 9. The method of Method Embodiment 8, further comprising: operating the MANC to detect (1018) that interconnectivity links to the first AP have been restored; and operating the MANC, in response to the MANC detecting (1018) that interconnectivity links to the first AP have been restored, to instruct (1020) the first AP to resume normal operation.
Method Embodiment 10. The method of Method Embodiment 7, further comprising: operating the MANC, in response to the MANC receiving (1024) a failure message indicating a first radio failure at the first AP (e.g., due to a hardware issue) or a first service network failure at the first AP, to instruct (1026) the first AP to switch from a normal mode of operation to a failure mode of operation in which received packets are assigned for transmission to the second and third service networks at the first AP without first being assigned to the first service network for transmission.
Method Embodiment 11. The method of Method Embodiment 10, further comprising: operating the MANC to receive (1028) a failure resolved message from the first AP indicating that the first radio or first service network failure condition has been resolved; and operating the MANC to instruct (1030) the first AP to switch back to the normal mode of operation in response to the failure resolved message.

### NUMBERED LIST OF EXEMPLARY SYSTEM EMBODIMENTS

System Embodiment 1. A communications system (200) comprising: a first access point (AP) (206) including: a plurality of different radios (304, 306, 308); an interface (316) having a first IP address corresponding to the first AP (206); an IP packet buffer (318) used to supply packets to a used to supply packets to the plurality of different radios (304, 306, 308) included in said first AP (206); a higher order common MAC scheduler (320); a plurality of radio network MAC schedulers (324, 326, 328) including a first MAC scheduler (324) corresponding to a first radio (304), said first radio being one of said plurality of different radios (304, 306, 308); and a first processor (1302) configured to operate the first access point (206) to: receive (922), at the first access point (AP) (206), during a normal mode of AP operation, IP packets (322) that are directed to said first IP address and which are to be transmitted to one or more UEs (270, 271, 272) which are receiving service from the first AP (206); store (930) the received IP packets (322) in the IP packet buffer (318); operate (946) the higher order common MAC scheduler (320) to determine which of the plurality of radio network MAC schedulers (324, 326, 328) is to schedule transmission of individual IP packets stored in the IP packet buffer (318) (e.g., with said determination as to which radio network MAC scheduler (324, 326, 328) is to schedule the transmission of an IP packet also being a determination as to which radio (304, 306, or 308) is to transmit the packet since the determined scheduler corresponds to a particular radio (304, 306 or 308) and radio network at the first AP 206); and operate (960) the first MAC scheduler (324) to control a first radio (304) at the first AP (206) to transmit packets to a first UE (270) over a first radio network (e.g., 60 GHz radio network).
System Embodiment 2. The communications system of System Embodiment 1, wherein said first processor (1302) is further configured to operate the first AP (206) to: receive (966) an acknowledgment from the first UE (270) indicating that the first packet was successfully received by the first UE (e.g., radio (304) receives an ACK from the first UE with regard to the first packet); and remove (970) a first transmitted packet from the IP packet buffer (318) in response to a receiving an acknowledgement from the first UE (270) to which the first packet was transmitted indicating successful receipt of the first packet by the first UE (e.g., in response to the first radio (304) receiving an ack to the first packet that was transmitted to the first UE (270) the first AP (206) deletes the successfully communicated first packet from the IP packet buffer 318)).
System Embodiment 3. The communications system of System Embodiment 2, wherein said first processor is further configured to: operate the first access point (206) to determine (972) that transmission of a second packet to the first UE (270) from the first radio (304) was unsuccessful (e.g., an acknowledgement was not received from the first UE (270) in response to transmission of the first packet from the first radio (304) within a predetermined time or a NAK was received from the first UE (270) with regard to the second packet); and operate the higher order common MAC scheduler (220) at the first AP (206) to assign (980) the second packet to a second MAC scheduler (326) to schedule retransmission of the second packet stored in said IP packet buffer (318) to the first UE (270) over a second communications network, said second communications network being different from said first communications network (e.g., the 5 GHz network or the CBRS network if the 5 GHz network is unavailable); and operate the second MAC scheduler (326) to control (984) a second radio (306) at the first AP (206) to transmit the second packet to the first UE (270) over the second radio network (e.g., 5 GHz radio network).
System Embodiment 4. The communications system of System Embodiment 1, wherein said first processor is further configured to: operate the first AP (206) to receive (928), at the first AP (206) an additional IP packet directed to said first IP address, said additional IP packet being a packet which is to be transmitted to an additional UE (e.g., UE3 272) receiving service at said first AP (206) but which is outside the range of said first radio (304) and said second radio (306); operate the first AP (206) to store (936) the additional IP packet in the IP packet buffer (318) used to supply packets to a plurality of different radios (304, 306, 308); and operate the higher order common MAC scheduler (320) to assign (950) the additional packet to a third MAC scheduler (326) which is used to control a third radio (308) at the first AP (206).
System Embodiment 5. The communications system of System Embodiment 4, wherein said first processor is further configured to: operate the third MAC scheduler (328) to control (960) the third radio (308) to transmit the additional packet over a third wireless network packet link to the additional UE (372).
System Embodiment 6. The communications system of System Embodiment 5, wherein said first processor is further configured to: check (990), prior to assigning the additional packet to the third MAC scheduler (328) (e.g., at a higher order common MAC scheduler (320) of the first AP (206)), that said additional packet is directed to a UE entitled to receive CBRS service and that said additional UE (272) to which the additional packet is directed is out of range of the first and second radios (304, 306); and wherein the higher order common MAC scheduler (320) is operated to assign (992) the additional packet to the third MAC scheduler (328) in response to determining that the additional UE (272) to which the additional packet is directed is entitled to receive CBRS service and that the additional UE (272) is out of range of the first and second radios (304, 306).
System Embodiment 7. The communications system of System Embodiment 1, wherein said communications system further includes a Multi-Access Network Controller (MANC) (260 or 1400), said MANC including: a second processor (1402); and a receiver (1416); and wherein said second processor (1416) is configured to operate the MANC to perform one or both of: i) detecting failure of one or more interconnectivity links between access points (APs) (e.g., by detecting a ping response over a interconnectivity link); and ii) receiving (e.g., via receiver 1416) a failure message from an AP indicating failure of a radio at the AP or indicating failure of a service network at the AP from which the message is received.
System Embodiment 7A. The communications system of System Embodiment 7, wherein said MANC further includes memory (1412) coupled to said second processor (1402), and wherein said second processor (1402) is further configured to: store (1010) network information (e.g., in a storage device which is part of the MANC or accessible to the MANC) in said memory (1412), said network information (e.g., network information table) including access point (AP) interconnectivity link information (e.g., information indicating AP interconnectivity information); and operate the MANC to test (1012) AP interconnectivity links (e.g., send a ping message over the link and check for a response) to detect failure of AP interconnectivity links.
System Embodiment 8. The communications system (200) of System Embodiment 7A, wherein said second processor (1402) is further configured to: operate the MANC, in response to the MANC detecting that all interconnectivity links of the first type to the first AP have failed, to instruct (1016) the first AP to switch from a normal mode of operation to a failure mode of operation in which received packets are assigned for transmission to the second and third service networks at the first AP without first being assigned to the first service network for transmission.
System Embodiment 9. The communications system (200) of System Embodiment 8, wherein said second processor (1402) is further configured to: operate the MANC to detect (1018) that interconnectivity links to the first AP have been restored; and operate the MANC, in response to the MANC detecting (1018) that interconnectivity links to the first AP have been restored, to instruct (1020) the first AP to resume normal operation.
System Embodiment 10. The communications system of System Embodiment 7, wherein said second processor (1402) is further configured to: operate the MANC, in response to the MANC receiving (1024) a failure message indicating a first radio failure at the first AP (e.g., due to a hardware issue) or a first service network failure at the first AP, to instruct (1026) the first AP to switch from a normal mode of operation to a failure mode of operation in which received packets are assigned for transmission to the second and third service networks at the first AP without first being assigned to the first service network for transmission.
System Embodiment 11. The communications system of System Embodiment 10, wherein said second processor (1402) is further configured to: operate the MANC to receive (1028) a failure resolved message from the first AP indicating that the first radio or first service network failure condition has been resolved; and operate the MANC to instruct (1030) the first AP to switch back to the normal mode of operation in response to the failure resolved message.

### NUMBERED LIST OF EXEMPLARY NON-TRANSITORY COMPUTER READABLE MEDIUM EMBODIMENTS

Non-transitory Computer Readable Medium Embodiment 1. A non-transitory computer readable medium (1312) including machine executable instructions, which when executed by a processor (1302) of a first access point (206) cause the first AP to perform the steps of: receiving (922), at a first access point (AP) (206) including an interface (316) having a first IP address corresponding to the first AP (206) during a normal mode of AP operation, IP packets (322) that are directed to said first IP address and which are to be transmitted to one or more UEs (270, 271, 272) which are receiving service from the first AP (206); storing (930) the received IP packets (322) in an IP packet buffer (318) used to supply packets to a plurality of different radios (304, 306, 308) included in said first AP (206); operating (946) a higher order common MAC scheduler (320) at the first AP to determine which of a plurality of radio network MAC schedulers (324, 326, 328) is to schedule transmission of individual IP packets stored in the IP packet buffer (318) (e.g., with said determination as to which radio network MAC scheduler (324, 326, 328) is to schedule the transmission of an IP packet also being a determination as to which radio (304, 306, or 308) is to transmit the packet since the determined scheduler corresponds to a particular radio (304, 306 or 308) and radio network at the first AP 206), said plurality of radio network MAC schedulers (324, 326, 328) including a first MAC scheduler (324) corresponding to a first radio (304), said first radio being one of said plurality of different radios (304, 306, 308); and operating (960) the first MAC scheduler (324) to control a first radio (304) at the first AP (206) to transmit packets to a first UE (270) over a first radio network (e.g., 60 GHz radio network).
Non-transitory Computer Readable Medium Embodiment 2. A non-transitory computer readable medium (1412) including machine executable instructions, which when executed by a processor (1402) of a Multi-Access Network Controller (MANC) (260 or 1400), cause the MANC to perform one or both of: i) detecting failure of one or more interconnectivity links between access points (APs) (e.g., by detecting a ping response over an interconnectivity link); and ii) receiving a failure message from an AP indicating failure of a radio at the AP or indicating failure of a service network at the AP from which the message is received.

The techniques of various embodiments may be implemented using software, hardware and/or a combination of software and hardware. Various embodiments are directed to apparatus, e.g., user equipment (UE) devices, APs, MANC devices, and/or elements. Various embodiments are also directed to methods, e.g., method of controlling and/or operating user equipment (UE) devices, core network devices, wireless devices including various UE devices such as, mobile devices, smartphones, subscriber devices, desktop computers, printers, IPTV, laptops, tablets, network edge devices. Various embodiments are also directed to a machine, e.g., computer, readable medium, e.g., ROM, RAM, CDs, hard discs, etc., which include machine readable instructions for controlling a machine to implement one or more steps of a method, e.g., any one of the methods described herein. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user equipment (UE) devices, APs and MANCs described herein are implemented using one or more components to perform the steps corresponding to one or more methods. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., user (UE) devices, APs and MANCs core network interfacing devices, e.g., N3IWF devices, TNGF devices, etc., core network devices include a processor configured to control the device to perform steps in accordance with one of the methods described herein.

The configuration of the processor may be achieved by using one or more components, e.g., software components, to control processor configuration and/or by including hardware in the processor, e.g., hardware components, to perform the recited steps and/or control processor configuration.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, an AP, UE or MANC for example but could be in other devices as well. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method, the method comprising:
receiving, at a first access point (AP) including an interface having a first IP address corresponding to the first AP during a normal mode of AP operation, IP packets that are directed to said first IP address and which are to be transmitted to one or more User Equipment devices (UEs) which are receiving service from the first AP;
storing the received IP packets in an IP packet buffer used to supply packets to a plurality of different radios included in said first AP;
operating a higher order common medium access control (MAC) scheduler at the first AP to determine which of a plurality of radio network MAC schedulers is to schedule transmission of individual IP packets stored in the IP packet buffer, said plurality of radio network MAC schedulers including a first MAC scheduler corresponding to a first radio, said first radio being one of said plurality of different radios; and
operating the first MAC scheduler to control a first radio at the first AP to transmit packets to a first UE over a first radio network.

2. The communications method of claim 1, further comprising:
operating the first access point to receive an acknowledgment from the first UE indicating that the first packet was successfully received by the first UE; and
operating the first access point to remove a first transmitted packet from the IP packet buffer in response to a receiving an acknowledgement from the first UE to which the first packet was transmitted indicating successful receipt of the first packet by the first UE.

3. The communications method of claim 2, further comprising:
operating the first access point to determine that transmission of a second packet to the first UE from the first radio was unsuccessful; and
operating the higher order common MAC scheduler at the first AP to assign the second packet to a second MAC scheduler to schedule retransmission of the second packet stored in said IP packet buffer to the first UE over a second communications network, said second communications network being different from said first communications network; and
operating the second MAC scheduler to control a second radio at the first AP to transmit the second packet to the first UE over the second radio network.

4. The method of claim 1, further comprising:
receiving, at the first AP an additional IP packet directed to said first IP address, said additional IP packet being a packet which is to be transmitted to an additional UE receiving service at said first AP but which is outside the range of said first radio and said second radio;
storing the additional IP packet in the IP packet buffer used to supply packets to a plurality of different radios; and
operating the higher order common MAC scheduler to assign the additional packet to a third MAC scheduler which is used to control a third radio at the first AP.

5. The method of claim 4, further comprising:
operating the third MAC scheduler to control the third radio to transmit the additional packet over a third wireless network packet link to the additional UE.

6. The method of claim 5, further comprising:
checking, prior to assigning the additional packet to the third MAC scheduler, that said additional packet is directed to a UE entitled to receive Citizens Broadband Radio Service (CBRS) service and that said additional UE to which the additional packet is directed is out of range of the first and second radios; and
wherein the higher order common MAC scheduler is operated to assign the additional packet to the third MAC scheduler in response to determining that the additional UE to which the additional packet is directed is entitled to receive CBRS service and that the additional UE is out of range of the first and second radios.

7. The method of claim 1, further comprising:
operating a Multi-Access Network Controller (MANC) to perform one or both of:
i) detecting failure of one or more interconnectivity links between access points (APs); and
ii) receiving a failure message from an AP indicating failure of a radio at the AP or indicating failure of a service network at the AP from which the message is received.

8. The method of claim 7, further comprising:
storing network information, said network information including access point (AP) interconnectivity link information; and
operating the MANC to test AP interconnectivity links to detect failure of AP interconnectivity links; and
operating the MANC, in response to the MANC detecting that all interconnectivity links of the first type to the first AP have failed, to instruct the first AP to switch from a normal mode of operation to a failure mode of operation in which received packets are assigned for transmission to the second and third service networks at the first AP without first being assigned to the first service network for transmission.

9. The method of claim 8, further comprising:
operating the MANC to detect that interconnectivity links to the first AP have been restored; and
operating the MANC, in response to the MANC detecting that interconnectivity links to the first AP have been restored, to instruct the first AP to resume normal operation.

10. The method of claim 7, further comprising:
operating the MANC, in response to the MANC receiving a failure message indicating a first radio failure at the first AP or a first service network failure at the first AP, to instruct the first AP to switch from a normal mode of operation to a failure mode of operation in which received packets are assigned for transmission to the second and third service networks at the first AP without first being assigned to the first service network for transmission.

11. The method of claim 10, further comprising:
operating the MANC to receive a failure resolved message from the first AP indicating that the first radio or first service network failure condition has been resolved; and
operating the MANC to instruct the first AP to switch back to the normal mode of operation in response to the failure resolved message.

12. A communications system comprising:
a first access point (AP) including:
a plurality of different radios;
an interface having a first IP address corresponding to the first AP;
an IP packet buffer used to supply packets to a used to supply packets to the plurality of different radios included in said first AP;
a higher order medium access control (MAC) scheduler;
a plurality of radio network MAC schedulers including a first MAC scheduler corresponding to a first radio, said first radio being one of said plurality of different radios; and
a first processor configured to operate the first access point to:
receive, at the first access point (AP), during a normal mode of AP operation, IP packets that are directed to said first IP address and which are to be transmitted to one or more User Equipment devices (UEs) which are receiving service from the first AP;
store the received IP packets in the IP packet buffer;
operate the higher order common MAC scheduler to determine which of the plurality of radio network MAC schedulers is to schedule transmission of individual IP packets stored in the IP packet buffer; and
operate the first MAC scheduler to control a first radio at the first AP to transmit packets to a first UE over a first radio network.

13. The communications system of claim 12, wherein said first processor is further configured to operate the first AP to:
receive an acknowledgment from the first UE indicating that the first packet was successfully received by the first UE; and
remove a first transmitted packet from the IP packet buffer in response to a receiving an acknowledgement from the first UE to which the first packet was transmitted indicating successful receipt of the first packet by the first UE.

14. The communications system of claim 13, wherein said first processor is further configured to:
operate the first access point to determine that transmission of a second packet to the first UE from the first radio (304) was unsuccessful; and
operate the higher order common MAC scheduler at the first AP to assign the second packet to a second MAC scheduler to schedule retransmission of the second packet stored in said IP packet buffer to the first UE over a second communications network, said second communications network being different from said first communications network; and
operate the second MAC scheduler to control a second radio at the first AP to transmit the second packet to the first UE over the second radio network.

15. The communications system of claim 12, wherein said first processor is further configured to:
operate the first AP to receive, at the first AP an additional IP packet directed to said first IP address, said additional IP packet being a packet which is to be transmitted to an additional UE receiving service at said first AP (206) but which is outside the range of said first radio and said second radio;
operate the first AP to store the additional IP packet in the IP packet buffer used to supply packets to a plurality of different radios; and
operate the higher order common MAC scheduler to assign the additional packet to a third MAC scheduler which is used to control a third radio at the first AP.

16. The communications system of claim 15, wherein said first processor is further configured to:
operate the third MAC scheduler to control the third radio to transmit the additional packet over a third wireless network packet link to the additional UE.

17. The communications system of claim 16, wherein said first processor is further configured to:
check, prior to assigning the additional packet to the third MAC scheduler, that said additional packet is directed to a UE entitled to receive Citizens Broadband Radio Service (CBRS) service and that said additional UE to which the additional packet is directed is out of range of the first and second radios; and
wherein the higher order common MAC scheduler is operated to assign the additional packet to the third MAC scheduler in response to determining that the additional UE to which the additional packet is directed is entitled to receive CBRS service and that the additional UE is out of range of the first and second radios.

18. The communications system of claim 12, wherein said communications system further includes a Multi-Access Network Controller (MANC), said MANC including:
a second processor; and
a receiver; and
wherein said second processor is configured to operate the MANC to perform one or both of: i) detecting failure of one or more interconnectivity links between access points (APs); and ii) receiving a failure message from an AP indicating failure of a radio at the AP or indicating failure of a service network at the AP from which the message is received.

19. The communications system of claim 18, wherein said MANC further includes memory coupled to said second processor, and
wherein said second processor is further configured to:
store network information in said memory, said network information including access point (AP) interconnectivity link information; and
operate the MANC to test AP interconnectivity links to detect failure of AP interconnectivity links; and operate the MANC, in response to the MANC detecting that all interconnectivity links of the first type to the first AP have failed, to instruct (1016) the first AP to switch from a normal mode of operation to a failure mode of operation in which received packets are assigned for transmission to the second and third service networks at the first AP without first being assigned to the first service network for transmission.

20. A non-transitory computer readable medium including machine executable instructions, which when executed by a processor of a first access point cause the first AP to perform the steps of:
receiving, at a first access point (AP) including an interface having a first IP address corresponding to the first AP during a normal mode of AP operation, IP packets that are directed to said first IP address and which are to be transmitted to one or more User Equipment devices (UEs) which are receiving service from the first AP;
storing the received IP packets in an IP packet buffer used to supply packets to a plurality of different radios included in said first AP;
operating a higher order common medium access control (MAC) scheduler at the first AP to determine which of a plurality of radio network MAC schedulers is to schedule transmission of individual IP packets stored in the IP packet buffer, said plurality of radio network MAC schedulers including a first MAC scheduler corresponding to a first radio, said first radio being one of said plurality of different radios; and
operating the first MAC scheduler to control a first radio at the first AP to transmit packets to a first UE over a first radio network.
